(19) United States
(12) Patent Application Publication
(10) Pub. No.: US 2019/0164084 A1
(43) Pub. Date: May 30, 2019

(54) METHOD OF AND SYSTEM FOR GENERATING PREDICTION QUALITY PARAMETER FOR A PREDICTION MODEL EXECUTED IN A MACHINE LEARNING ALGORITHM

(71) Applicant: YANDEX EUROPE AG, Luzern (CH)

(72) Inventor: Andrey Vladimirovich GULIN, Moscow region (RU)

(21) Appl. No.: 16/000,809

(22) Filed: Jun. 5, 2018

(30) Foreign Application Priority Data
Nov. 24, 2017 (RU) 2017140969

(51) Int. Cl. G06N 99/00; G06N 5/04; G06F 17/30

(52) U.S. Cl. CPC G06N 99/005; G06F 17/30961; G06N 5/045

(57) ABSTRACT

A method of determining a prediction quality parameter for a decision tree in a decision tree prediction model for evaluating prediction quality of the decision tree prediction model. The method comprises organizing the set of training objects into an ordered list of training objects such that for each given training object in the ordered list of training objects there is at least one of: (i) a preceding training object that occurs before the given training object and (ii) a subsequent training object that occurs after the given training object. The method further comprises generating the prediction quality parameter for the given level of a decision tree by generating, for a given training object that has been categorized into the given child node, a prediction quality parameter based on targets of only those training objects that occur before the given training object.

### CROSS-REFERENCE

The present application claims priority to Russian Patent Application No. 2017140969, entitled “Method Of And System For Generating Prediction Quality Parameter For A Prediction Model Executed In A Machine Learning Algorithm”, filed Nov. 24, 2017, the entirety of which is incorporated herein by reference.

### FIELD

The present technology relates to systems and methods for generating a prediction model used in Machine Learning Algorithms (MLAs). In particular, the present technology is directed to a method of and a system for generating prediction quality parameter for a prediction model executed in the MLA.

### BACKGROUND

Machine learning algorithms (MLAs) are used to address multiple needs in computer-implemented technologies. Typically, the MLAs are used for generating a prediction associated with a user interaction with a computer device. One example of an area where such prediction is required is user interaction with the content available on the Internet (as an example).

The volume of available information through various Internet resources has grown exponentially in the past couple of years. Several solutions have been developed in order to allow a typical user to find the information that the user is looking for. One example of such a solution is a search engine. Examples of the search engines include GOOGLE™ search engine, YANDEX™ search engine, YAHOO!™ search engine and the like. The user can access the search engine interface and submit a search query associated with the information that the user is desirous of locating on the Internet. In response to the search query, the search engine provides a ranked list of search results. The ranked list of search results is generated based on various ranking algorithms employed by the particular search engine that is being used by the user performing the search. The overall goal of such ranking algorithms is to present the most relevant search results at the top of the ranked list, while less relevant search results would be positioned on less prominent positions of the ranked list of search results (with the least relevant search results being located towards the bottom of the ranked list of search results).

The search engines typically provide a good search tool for a search query that the user knows apriori that she/he wants to search. In other words, if the user is interested in obtaining information about the most popular destinations in Italy (i.e. a known search topic), the user could submit a search query: “The most popular destinations in Italy?” The search engine will then present a ranked list of Internet resources that are potentially relevant to the search query. The user can then browse the ranked list of search results in order to obtain information she/he is interested in as it related to places to visit in Italy. If the user, for whatever reason, is not satisfied with the uncovered search results, the user can re-run the search, for example, with a more focused search query, such as “The most popular destinations in Italy in the summer?”, “The most popular destinations in the South of Italy?”, “The most popular destinations for a romantic getaway in Italy?”.

In the search engine example, the MLA is used for generating the ranked search results. When the user submits a search query, the search engine generates a list of relevant web resources (based on an analysis of crawled web resources, an indication of which is stored in a crawler database in a form of posting lists or the like). The search engine then executes the MLA to rank the so-generated list of search results. The MLA ranks the list of search results based on their relevancy to the search query. Such the MLA is “trained” to predict relevancy of the given search result to the search query based on a plethora of “features” associated with the given search result, as well as indications of past users' interactions with search results when submitting similar search queries in the past.

As has been alluded to above, the search engines are useful when the user knows what the user is looking for (i.e. has a particular search intent in mind). There is another approach that has been proposed for allowing the user to discover content and, more precisely, to allow for discovering and/or recommending content that the user may not be expressly interested in searching for. In a sense, such systems recommend content to the user without an express search request based on explicit or implicit interests of the user.

An example of such a system is a FLIPBOARD™ recommendation system, which system aggregates and recommends content from various social networks. The FLIPBOARD recommendation system presents the uncovered content in a “magazine style” format, where the user can “flip” through the pages with the recommended/aggregated content. The recommendation system collects content from social media and other websites, presents it in magazine format, and allows users to “flip” through their social-networking feeds and feeds from websites that have partnered with the company, effectively “recommending” content to the user even though the user may not have expressly expressed her/his desire in the particular content. Another example of a recommendation system is YANDEX.ZEN™ recommendation system, which generates and presents user-personalized content to the user when the user initiates an application associated with Yandex.Zen, which can be a dedicated application or a landing page of a browser application.

In order to generate the ranked search results in a search engine system or a list of recommended resources in a typical recommendation system, the respective system utilizes the MLA the recommended content from various content sources available on the Internet.

Overview of MLAs

There are many different types of MLAs known in the art. Broadly speaking, there are three types of MLAs: supervised learning based MLAs, unsupervised learning based MLAs and reinforcement learning based MLAs.

Supervised learning MLA process is based on a target-outcome variable (or dependent variable), which is to be predicted from a given set of predictors (independent variables). Using these set of variables, the MLA (during training) generates a function that maps inputs to desired outputs. The training process continues until the MLA achieves a desired level of accuracy on the validation data. Examples of supervised learning based MLAs include: Regression, Decision Tree, Random Forest, Logistic Regression, etc.

Unsupervised learning MLA does not involve a target or outcome variable to predict per se. Such MLAs are used for clustering a population of values into different groups, which is widely used for segmenting customers into different groups for specific intervention. Examples of unsupervised learning MLA include: Apriori algorithm, K-means.

Reinforcement learning MLA is trained to make specific decisions. During training, the MLA is exposed to a training environment where it trains itself continually using trial and error. The MLA learns from past experience and tries to capture the best possible knowledge to make accurate decisions. Example of reinforcement learning MLA is a Markov Decision Process.

Decision tree based MLAs is an example of supervised learning type of the MLA. This type of MLAs uses a decision tree (as a predictive model) to go from observations about an item (represented in the branches) to conclusions about the item's target value (represented in the leaves). Tree models where the target variable can take a discrete set of values are called classification trees; in these tree structures, leaves represent class labels and branches represent conjunctions of features that lead to those class labels. Decision trees where the target variable can take continuous values (typically real numbers) are called regression trees.

In order for the decision trees based MLA to work, it needs to be “built” or trained using a training set of objects containing a large plurality of training objects (such as documents, events, or the like). These training objects are “labelled” by human assessors. As an example, a human assessor can rank a given training object as “not interesting”, “interesting” or “highly interesting”.

Gradient Boosting

Gradient boosting is one approach to building an MLA based on decision trees, whereby a prediction model in the form of an ensemble of trees is generated. The ensemble of trees is built in a stage-wise manner Each subsequent decision tree in the ensemble of decision trees focuses training on those previous decision tree iterations that were “weak learners” in the previous iteration(s) of the decision trees ensemble (i.e. those that are associated with poor prediction/high error).

Generally speaking, boosting is a method aimed at enhancing prediction quality of the MLA. In this scenario, rather than relying on a prediction of a single trained algorithm (i.e. a single decision tree) the system uses many trained algorithms (i.e. an ensemble of decision trees), and makes a final decision based on multiple prediction outcomes of those algorithms.

In boosting of decision trees, the MLA first builds a first tree, then a second tree, which enhances the prediction outcome of the first tree, then a third tree, which enhances the prediction outcome of the first two trees and so on. Thus, the MLA in a sense is creating an ensemble of decision trees, where each subsequent tree is better than the previous, specifically focusing on the weak learners of the previous iterations of the decision trees. Put another way, each tree is built on the same training set of training objects, however training objects, in which the first tree made “mistakes” in predicting are prioritized when building the second tree, etc. These “tough” training objects (the ones that previous iterations of the decision trees predict less accurately) are weighted with higher weights than those where a previous tree made satisfactory prediction.

Greedy Algorithms

When generating the decision trees (using, for example, the gradient boosting approach), it is known to use greedy algorithms A greedy algorithm is an algorithmic paradigm that follows the problem solving heuristic of making the locally optimal choice at each stage (for example, at each level of the decision tree) with an outlook of finding a global optimum. In building the decision trees, the use of the greedy algorithm can be summarized as following: for each level of the decision tree, the MLA tries to find the most optimal value (of the feature and/or the split)—this is the local optimal solution. Once the optimal value for the given node is determined, when the MLA moves to generating a lower level of the decision tree, the previously determined values for the upper nodes are “frozen”—i.e. taken “as is” for the given iteration of the decision tree in the ensemble of the decision trees.

As in a case of a single tree, each tree in the ensemble of trees is built in a greedy fashion, which means that when the MLA is selecting a feature and a split for each node of the tree, the MLA makes a selection that is locally optimal, e.g. the best for the particular node, not for the entire tree in general.

Oblivious Decision Trees

Once the best feature and split are selected for a given node, the algorithm then goes to a child node of the given node and executes the greedy selection of feature and split for that child node. In certain implementations, when selecting a feature for a given node, the MLA algorithm can not use features used in nodes on higher levels of tree depth. In other implementations, for each depth level of the MLA analyzes all possible features, regardless of whether they were used on previous levels. Such trees are called “oblivious” trees, because at each level the tree “forgets” that it used a particular feature on a previous level and considers the feature again. In order to select the best feature and split for the node, a gain function is calculated for each possible variant). The option (feature and split value) with the highest gain is selected.

Prediction Quality Parameter

When a given tree is built, in order to determine the quality of the prediction of the given tree (or a given level of the given tree, as the given tree is being built), the MLA calculates a metric (i.e. a “score”), which denotes how close the current iteration of the model, which includes the given tree (or the given level of the given tree) and preceding trees, has gotten in its prediction to the correct answers (targets). The score of the model is calculated based on the predictions made and actual target values (correct answers) of the training objects used for training.

When the first tree is built, the MLA selects values of a first feature and a first split for a root node of the first tree and estimates the quality of such model. In order to do so, the MLA “feeds” the training objects to the first tree in a sense “descending” the training objects through the branches of the decision tree, and the so-fed training objects are split into two (or maybe more) different leafs of the first tree at the first node split (i.e. they get “categorized” by the decision tree or, more specifically, the decision tree model attempts to predict the target of the training object being descended through the decision tree model). Once all the training objects are categorized, a prediction quality parameter is calculated—in a sense determining how close the categorization of objects is to the actual values of the targets.

More specifically, knowing the target values of the training objects, the MLA calculates the prediction quality parameter (e.g. information gain or the like) for this first feature—first split node and then selects a second feature with a second split for the root node. For this second variant of feature and split for the root node, the MLA executes the same steps as it did with the first variant (the MLA feeds training objects to the tree and calculates the resulting metric using the second variant of a combination of the feature and the split for the root node).

The MLA then repeats the same process with the third, fourth, fifth, etc. features and splits variants for the root node until the MLA covers all possible variants of the feature and the split and then the MLA chooses the feature and split variant for the root node which yields the best prediction outcome (i.e. has the highest metric).

Once the feature and split variant for the root node are selected, the MLA proceeds to the child nodes of the root node and selects features and splits for the child nodes same way as it did for the root node. The process is then repeated for further child nodes of the first tree until the decision tree is built.

Then, according to the boosting approach, the MLA moves to build the second three. The second tree is aimed to enhance the prediction results of the first tree. It should “correct” prediction mistakes of the first tree. For that to occur, the second tree is built on a training object where examples, in which the first tree made prediction made prediction errors, are weighted with higher weights than examples in which the first tree rendered a correct prediction. The second tree is built similarly to how the first tree has been build.

With this approach, tens, hundreds or even thousands of threes are consequently built. Each of the subsequent tree in the ensemble of trees enhancing prediction quality of the previous ones.

U.S. Pat. No. 8,572,071 (published on Oct. 29, 2013 to Pottenger et al. and assigned to Rutgers, the State University of New Jersey) discloses a method and apparatus for transforming data in vector form. Each vector is composed of a set of attributes that are either Boolean or have been mapped to Boolean form. The vectors may or may not fall into categories assigned by a subject matter expert (SME). If categories exist, the categorical labels divide the vectors into subsets. The first transformation calculates a prior probability for each attribute based on the links between attributes in each subset of the vectors. The second transformation computes a new numeric value for each attribute based on the links between attributes in each subset of the vectors. The third transformation operates on vectors that have not been categorized. Based on the automatic selection of categories from the attributes, this transformation computes a new numeric value for each attribute based on the links between attributes in each subset of the vectors.

U.S. Pat. No. 9,639,807 (published on May 2, 2017 to Berengueres et al. and assigned to Berengueres et al.) discloses a method comprising: providing training data for training at least one mathematical model, wherein the training data is based on past flight information of a plurality of passengers, and the training data comprises a first set of vectors and an associated target variable for each passenger in the plurality of passengers; training at least one mathematical model with the training data; and providing a second set of vectors relating to past flight information of the passenger as inputs to the trained at least one mathematical model and calculating an output of the trained at least one mathematical model based on the inputs, wherein the output represents a prediction of future flight activities of the passenger.

### SUMMARY

Embodiments of the present technology have been developed based on developers' appreciation of at least one technical problem associated with the prior art approaches to building decision trees.

### Comprehension of the Machine-Learning Model

The comprehension of the machine-learning model refers to one or more combinations of features selected from a set of features to generate one or more tree models forming the machine-learning models. As a general rule, the more combinations of features in the one or more tree models, the better the quality of the machine-learning model and, as a result, the better the comprehension of the machine-learning model. Methodologies and/or algorithms used to select one or more combinations of features may result, at least under certain operating conditions, in a non-optimal comprehension. As an example, algorithms such as the greedy algorithm may result in a selection of sub-sets of features from a set of features that are “too similar” between the multiple tree models forming the machine-learning models.

“Too similar” refers to a situation wherein a first sub-set of features associated with a first tree model and a second sub-set of features comprise “too many” common features which can also be described as a too important overlap between the features of the first tree model and the features of the second tree model. In some instances, some features from the set of features may even be completely disregarded and therefore never selected to generate the tree models.

One of the reasons associated with this situation may be explained by the facts that some algorithms, such as the greedy algorithm, are designed to select a “best” feature for a given level of a tree model based on a determination that a “feature” is more likely to be a “better” feature even though such determination on a feature-by-feature basis may result in a lower overall quality of the tree model. This situation may be even more prevalent wherein certain features are inherently “strong” features (i.e., with an important positive impact in the quality of the tree model) even though they are not selected as such by the existing algorithms Such features may include features of integer type and/or category type that are typically associated with more than two branches upon being selected as a node in one of the tree models (as opposed to features of binary type that are typically associated with no more than two branches upon being selected as a node in one of the tree models).

This problem can be generally referred to as a “model bias”.

### Overfitting of the Machine-Learning Model

In some instances, the algorithms used to generate the machine-learning model, such as the greedy algorithm, may generate a so-called overfitting problem. Such problem may be characterised in occurrences of unreliable patterns between values generated by a function h(q,d) and features associated with the function h(q,d). The overfitting problem may occur when the algorithm generating the one or more tree models forming the machine-learning model tend to select and organize the features by “memorizing” a set of trends only relevant to the set of training objects rather than developing “trend” based on the set of training objects which will be relevant to unseen objects (i.e., the objects that are not part of the training process of the machine-learning model) and not just to the training objects of the set of training objects.

Put another way, the MLA may identify and learn patterns relevant only to the objects from the training set and does not develop a sufficient ability to generalize this knowledge and to efficiently use it on unseen object, which were not used for the training of the MLA.

### “Do not Look Ahead” Implementation—Single Decision Tree

As has been alluded to above, in conventional approaches to building the decision trees, after the given level of the given decision tree (or the given tree in its entirety) is built, the MLA needs to evaluate the prediction outcomes, which the then completed tree renders for training objects and then to evaluate the outcome of the model in each leaf.

To do so, in conventional MLAs, for each leaf, the MLA takes target values (correct answers) of training objects which got into that leaf and calculates an average of the correct predictions for those targets. This average is considered to be an outcome of the current iteration of the tree for each training objects which got to that leaf. The outcome, thus, is the same for all training objects in the given leaf (i.e. the quality of prediction is deemed to be the same for each training objects that got categorized into the given leaf).

Developers of the present technology have appreciated that such an approach to generating a prediction score of the decision tree model has a disadvantage. When the MLA calculates a prediction score for a given training objects in a leaf based on targets of all the training objects in the leaf, the MLA kind of “peeks” into the target of the given training objects and targets of the neighboring training objects in the leaf (which can be thought as “looking ahead”). That can cause the overfitting to appear comparatively earlier in the training process. This problem is also referred to by those of skill in the art as «data leakage» or «information leakage».

Developers of the present technology believe that non-limiting embodiments of the present technology allow reducing the effect of overfitting and increase the overall quality of prediction of the trained MLA. Embodiments of the present technology, broadly speaking, are directed to specific implementation of the MLA training using a “do not look ahead” paradigm.

In accordance with the non-limiting embodiments of the present technology, the MLA first creates an ordered list of all training objects to be processed during training of the MLA. In case the training objects have an inherent temporal relationship, the MLA organizes the training objects in accordance with this temporal relationship. In case the training objects do not have the inherent temporal relationship, the MLA organizes an ordered list of training objects based on a rule. For example, the MLA can create a random order of training objects. The random order becomes a proxy for temporal order of the training objects that are not otherwise associated with inherent temporal relationship.

Irrespective of how the order is generated, the MLA then “freezes” the training objects in the so-organized order. The so-organized order, in a sense, can be said to specify for each one training object, which other training object occur “before” and which occurs “after” (even if the training objects are not associated with the inherent temporal relationship).

Then when the MLA needs to evaluate the prediction quality using a given training object in the leaf, the prediction quality parameter is determined based on targets of only those training objects, which have “happened” (or “occurred”) before the given training object in the ordered list of training objects. To give a temporal analogy, the MLA uses only those training objects which have happened in the “past” relative to the given training objects. Thus, when determining prediction quality parameter for the given training object, the MLA does not “peek” into the future of the given training object (i.e. targets of those training objects that happened “in the future” relative to the given training object).

In other words, the MLA iteratively calculates the prediction quality features as each new training object gets categorized into the given leaf, using only those training objects that have already been categorized into the given leaf (and that occur earlier in the ordered list of training objects). The MLA then adds or averages all so-calculated prediction scores for the leaf and, then, eventually, for a given level of the decision tree using all leafs of the given level of the decision tree.

“Do not Look Ahead” Implementation—Multiple Decision Trees/Ensemble of Trees

In alternative implementations of the present technology, the “do not look ahead” paradigm is applied to multiple decision trees/ensemble of decision trees. More specifically, during the implementation of the gradient boosting of trees and building the ensemble of decision trees (each of which is built based on inter alia an outcome of preceding trees in order to enhance prediction quality of the previous decision trees). In accordance with non-limiting embodiments of the present technology, the MLA applies the “don't look ahead” approach, as described above in relation to building a single tree, to the process of building multiple decision trees, as part of an ensemble during the boosting approach.

In general, an MLA function ƒ(x) for a given training object x depends not only on targets of training objects which precede the given training object in the “timeline” (order) and got into the same leaf as the given training object in the current tree, but also on the approximations (i.e. predictions) for this training object x made by preceding decision trees. These predictions of the previous iterations of the decision trees are referred to herein as “approximations” or “prediction approximation parameter”. In other words, an approximation for a given training object x is a prediction made by the previously built trees, as well as the current iteration of the decision tree, for the given training object x.

Since at any given iteration of the building the decision trees in the ensemble of decision trees, training objects can be categorized into different leaves, for any given iteration of the building of decision trees, the approximation of the given training object x is calculated based on a different set of “prior training objects”—i.e. those training objects which precede the given training object in the “timeline” (order) and got into the same leaf as the given training object in the previous tree(s). Therefore, in order to create approximations for the given training object x, the MLA would need to store indications of all past predictions and approximations of all training objects using any possible combination of “prior training objects”.

With reference to FIG. 1, there is depicted a table 100, the table 100 storing prediction results for each of the training objects x. The table 100 maps a given training object 102, to its associated target 104 (i.e. the actual value of the target, which the MLA is attempting to predict) and its associated approximation 106 (i.e. a totality of predictions for the training object 102 made by previous iterations of the decision trees).

There is also schematically depicted an approximation vector 103. The approximation vector 103 is a vector of correct answers for all the depicted example objects (one through to one thousand in the illustration depicted in FIG. 1).

The approximation vector 103 can also be said to be a vector of outcomes of prediction of the prediction model currently deployed by the MLA as a whole. In other words, the approximation vector 103 represents prediction outcomes for all training objects 102, rendered by a combination of decision trees built at the current stage of boosting of the decision trees by the MLA. In the simplest implementation of the non-limiting embodiments of the present technology, each approximation of the approximation vector 103 is a sum of previous predictions for the given training object 102.

When the MLA initiates the boosting the decision trees, the approximation vector 103 contains only zeros (since no previous iterations of the decision trees have been built and, thus, no previous predictions outcomes are yet available). As the MLA continues to implement boosting (and, thus, building additional decision trees in the ensemble of the decision trees), through the focus on the tree models that were the “weakest learners” of the previous iterations of decision trees, the approximation vector 103 starts to resemble more and more a vector of targets (not depicted). In other words, the goal is, for the MLA while executing boosting, to bring approximation of the targets to the actual values of the targets as close as possible.

Turning back to the example of the training object x in a given leaf at a given bosting stage n, in accordance with the non-limiting embodiments of the present technology, a prediction for the training object x (i.e. a new approximation for the given boosting stage n), in a given new tree is a function of targets and approximations of training object(s) that (i) have been categorized (placed) into the same leaf as the training object x in the new tree and (ii) are located before the given training object x in the ordered list of training objects.

A formula can be applied to the calculation of the approximation:

f(x)=Σᵢ₌₁^{k}f(tᵢ)+Σᵢ₌₁^{k}g(approxᵢ), Formula 1

where i=1 . . . k are training object(s) that (i) have been categorized (placed) into the same leaf as the training object x in the new tree and (ii) are located before the given training object x in the ordered list of training objects.

Non-limiting embodiments of the present technology have been developed based on developers appreciation of at least one technical problem associated with applying the “do not look ahead” paradigm to the calculation of approximations when executing the gradient boosting of decision trees.

Let's consider a scenario, where the MLA, during execution of the decision tree boosting techniques, needs to calculate a prediction outcome for a 1000^{th} training object in a new tree built during the then current iteration of the boosting procedure. When the MLA calculates the approximation for the 1000^{th} training object, if a 3^{rd} training object got into the same leaf as the 1000^{th} training object, the MLA will calculate prediction outcome for the 1000^{th} training object using approximations for the 3^{rd} training object, i.e. a prediction made for the 3^{rd} training object made by the previous trees. However, the approximation for 3^{rd} training object is calculated using the “past” of not only the 3^{rd} training object (i.e. 1^{st} and 2^{nd} training objects), but using the “past” of the 1000^{th} training object (i.e. all training objects 1-1000).

Thus, developers of the present technology have appreciated the following problem associated with using approximations from past iterations of the decision trees. The MLA needs to store, for a given training object in a training set of a size N, N number of approximations for each given training object. In other words, for a given training object (e.g. the 3^{rd} training object), the MLA needs approximations calculated using the past of 3^{rd} training object itself as well as “pasts” of the 1^{st}, 2^{th}, 4^{th} . . . 1000^{th} training object.

This approach leads to the complexity of the MLA algorithm and computational resources need to increase quadratically. In other words, for the MLA system using training objects of the training set of the size N, the complexity of the MLA systems becomes N².

With reference to FIG. 2, there is depicted a schematic illustration of the root/basis for such a “quadratic explosion”. At 202, there is depicted an ordered list of training objects. At 204, there is depicted calculated approximations for each of the training objects of 202. At 208, there is depicted an example of calculating an approximation for the 1000^{th} training object based on the 3^{rd} training object (the 3^{rd} training object being located earlier than the 1000^{th} object in the ordered list of training objects depicted at 202 and having been categorized into the same leaf as the 1000^{th} object at the given iteration of the boosting of the decision trees in the ensemble of the decision trees.

In order to calculate the approximation of the 1000^{th} training object based on the 3^{rd} training object, the MLA needs to know the “past” of the 3^{rd} training object based on the past of the 1000^{th} training object (depicted at 212). This, in turn, results in the necessity to calculate and/or store approximations for all of the training objects based on all other training objects—depicted schematically, as a matrix 214.

Developers of the present technology have developed some of the non-limiting embodiments described herein to solve this problem by reducing the complexity (from square complexity to linear complexity), while preserving the quality of the prediction rendered by the MLA algorithm trained using the training set of the size N at an acceptable level. More specifically, embodiments of the present technology have been developed based on a premise that for each given training object, the MLA does not need to calculate and store all potential approximations, but only a subset of all possible approximations.

In accordance with non-limiting embodiments of the present technology, the MLA first, splits the ordered list of training object into chunks. With reference to FIG. 3, the MLA splits the ordered list of training objects into a plurality of chunks 301.

The plurality of chunks 301 comprises chunks of several levels—a first level chunks 302, a second level chunks 304, a third level chunks 306, a fourth level chunks 308, etc. In the depicted embodiment, each level of chunks (i.e. chunks of the first level chunks 302, the second level chunks 304, the third level chunks 306, and the fourth level chunks 308) contains two chunks—a first chunk and a second chunk of the given level. Naturally, in any given implementation of the non-limiting embodiments of the present technology, the number of levels in the plurality of chunks 301 can be different.

Each chunk of a given level chunks contains a certain pre-defined number of training objects. As an example only, a given first level chunk 310 of the first level chunks 302 contains 100 of the ordered training objects. In the depicted example, the first level chunks 302 contain two instances of the given first level chunks 310 (containing 100 training objects each or 200 training objects in total).

A given second level chunk 312 of the second level chunks 304, contains a number of training object that is greater than the number of training objects contained by the given first level chunk 310. In the depicted embodiment, the number of training objects stored in the given second level chunk 312 is twice the number of training objects stored by the given first level chunk 310.

More specifically, where the given first level chunk 310 contains 100 of the ordered training objects, the given second level chunk 312 contains 200 of the ordered training object. What it means, in turn, is that the given second level chunk 312 (such as the first given second level chunk 312) can contain the same ordered training objects as two given first level chunks 310. However, some of the second level chunks 312 (such as the second given second level chunk 312) have ordered training objects that do not belong to any of the first level chunks 310.

Thus, it can be said that a given training object can get allocated into several chunks of the plurality of chunks 301. For example, a 105^{th} training object is located in: a second given first level chunk 302 containing 100 ordered training objects, the first given second level chunk 312 containing 200 ordered training objects, a first given third level chunk (not numbered) containing 700 training objects, a first given fourth level chunk (not numbered) containing 800 training objects, etc. As another example, a 205^{th} training object is located in: none of the first level chunks 302 containing 100 ordered training objects, the second given second level chunk 312 containing 200 ordered training objects, the first given third level chunk (not numbered) containing 700 training objects, the first given fourth level chunk (not numbered) containing 800 training objects, etc.

Therefore, it can be said that the approximations of the training objects located in, for example, the first given second level chunk 312 containing 200 training objects are calculated based on all training objects located therein and none of the training objects located in the second given second level chunk (not numbered). Therefore, for the training objects located in the first given second level chunk 312 containing 200 training objects using the “past” of all training objects located therein.

To illustrate, let's consider the 205^{th} training object. The MLA calculates approximates for the 205^{th} training object based on those chunks where the 205^{th} training object is located (and all training objects located therein)—i.e. the second given second level chunk 312 containing 200 ordered training objects, the first given third level chunk (not numbered) containing 700 training objects, the first given fourth level chunk (not numbered) containing 800 training objects, etc. When the MLA needs to calculate approximates of the for the 407^{th} training object based on the 205^{th} training object being located in the same leaf as the 407^{th} training object (i.e. based on the “past” of the 407^{th} training object) the MLA uses approximates of the 205^{th} training object based solely on the first third level chunk (not numbered), i.e. the largest chunk that does not contain the future of the 407^{th} training object.

Put another way, in order to calculate prediction value for a given training object located in a given leaf, the MLA uses approximates “neighboring” training objects (i.e. those training objects located in the same leaf and located “earlier” in the ordered list of training objects). The approximates of the neighbouring training objects are taken based on the largest chunk, not containing the given training object, in other words, based on the largest chunk not containing data from the “future” of the given training object.

In some embodiments of the present technology, the MLA may pre-organize a plurality of ordered lists of training objects, i.e. generate different “timelines”. In some embodiments of the present technology, the MLA generated a pre-determined number of ordered lists, such as three (as an example only). In other words, the MLA can generate a first ordered list of training objects, a second ordered list of training objects, and a third ordered list of training objects. Each of the first ordered list of training objects, the second ordered list of training objects, and the third ordered list of training objects can have at least partially different orders of training objects specified therein.

Then, in operation, for each prediction, the MLA can use a randomly selected one of the first ordered list of training objects, the second ordered list of training objects, and the third ordered list of training objects. In alternatively embodiments of the present technology, the MLA can use a randomly picked one of the first ordered list of training objects, the second ordered list of training objects, and the third ordered list of training objects per decision tree of the ensemble of decision trees.

Single Decision Tree

In accordance with a first broad aspect of the present technology, there is provided a method of determining a prediction quality parameter for a decision tree in a decision tree prediction model, the given level of the decision tree having at least one node, the prediction quality parameter being for evaluating prediction quality of the decision tree prediction model at a given iteration of training of the decision tree. The method is executable at a machine learning system that executes the decision tree prediction model. The method comprises: accessing, from a non-transitory computer-readable medium of the machine learning system, a set of training objects, each training object of the set of training object containing an indication of a document and a target associated with the document; organizing the set of training objects into an ordered list of training objects, the ordered list of training objects is organized such that for each given training object in the ordered list of training objects there is at least one of: (i) a preceding training object that occurs before the given training object and (ii) a subsequent training object that occurs after the given training object; descending the set of training objects through the decision tree so that each one of the set of training objects gets categorized, by the decision tree model at the given iteration of training, into a given child node of the at least one node of the given level of the decision tree; generating the prediction quality parameter for the given level of a decision tree by: generating, for a given training object that has been categorized into the given child node, a prediction quality parameter, the generating being executed based on targets of only those training objects that occur before the given training object in the ordered list of training objects.

In some implementations of the method, the method further comprises for a given node having at least one training object categorized in the child node of the given node: amalgamating, into a node-level prediction quality prediction parameter, the prediction quality parameters of the at least one training object.

In some implementations of the method, the amalgamating, into the node-level prediction quality prediction parameter, the prediction quality parameters of the at least one training object comprises one of: adding all prediction quality parameters of the at least one training object, generating an average of prediction quality parameters of the at least one training object and applying a formula to prediction quality parameters of the at least one training object.

In some implementations of the method, the method further comprises: for the given level of the decision tree, the given level having at least one node, amalgamating into a total-level prediction quality parameter, node level quality prediction parameter the prediction quality parameters of the at least one node.

In some implementations of the method, the descending comprises: descending the set of training objects through the decision tree in an order of training object of the ordered list of training objects.

In some implementations of the method, the generating the prediction quality parameter for the given training object having a given position in the ordered list of training objects comprises: generating the prediction quality parameter based on targets of only those training objects that (i) occur on a position before the given position of the given training object in the ordered list of training objects and (ii) have been categorized in a same leaf.

In some implementations of the method, the organizing the set of training objects into an ordered list of training objects comprises: generating a plurality of ordered lists of training objects, each of the plurality of ordered lists of training objects being organized such that for each given training object in the ordered list of training objects there is at least one of: (i) a preceding training object that occurs before the given training object and (ii) a subsequent training object that occurs after the given training object; a given one of the plurality of ordered lists of training objects having a least partially different order from others of the plurality of ordered lists of training objects.

In some implementations of the method, the method further comprises selecting the given one of the plurality of ordered lists of training objects.

In some implementations of the method, the selecting is done for each iteration of generating of the prediction quality parameter.

In some implementations of the method, the selecting is done an entirety of a process of verification of prediction quality for a given decision tree.

In some implementations of the method, the set of training objects is associated with an inherent temporal relationship of training objects and wherein the organizing the set of training objects into the ordered list of training objects comprises organizing the set of training objects in accordance with the temporal relationship.

In some implementations of the method, the set of training objects is not associated with an inherent temporal relationship of training objects and wherein the organizing the set of training objects into the ordered list of training objects comprises organizing the set of training objects in accordance with a rule.

In some implementations of the method, the set of training objects is not associated with an inherent temporal relationship of training objects and wherein the organizing the set of training objects into the ordered list of training objects comprises organizing the set of training objects in a randomly generated order.

Ensemble of Decision Trees

In accordance with another broad aspect of the present technology, there is provided a method of determining a prediction quality parameter for a decision tree in a decision tree prediction model, the given level of the decision tree having at least one node, the prediction quality parameter being for evaluating prediction quality of the decision tree prediction model at a given iteration of training of the decision tree, the given iteration of training of the decision tree having at least one previous iteration of training of a previous decision tree, the decision tree and the previous decision tree forming an ensemble of tree generated using a decision tree boosting technique. The method is executable at a machine learning system that executes the decision tree prediction model. The method comprises: accessing, from a non-transitory computer-readable medium of the machine learning system, a set of training objects, each training object of the set of training object containing an indication of a document and a target associated with the document; organizing the set of training objects into an ordered list of training objects, the ordered list of training objects is organized such that for each given training object in the ordered list of training objects there is at least one of: (i) a preceding training object that occurs before the given training object and (ii) a subsequent training object that occurs after the given training object; descending the set of training objects through the decision tree so that each one of the set of training objects gets categorized, by the decision tree model at the given iteration of training, into a given child node of the at least one node of the given level of the decision tree; generating the prediction quality parameter for the given level of a decision tree by: generating, for a given training object that has been categorized into the given child node, a prediction quality approximation parameter, the generating being executed based on: targets of only those training objects that occur before the given training object in the ordered list of training objects; and at least one prediction quality approximation parameter of the given training object generated during the previous iteration of the training of the previous decision tree.

In some implementations of the method, the method further comprises calculating an indication of the at least one quality approximation parameter of the given training object generated during the previous iteration of the training of the previous decision tree.

In some implementations of the method, the calculating comprises: splitting the ordered list of training objects into a plurality of chunks, the plurality of chunks being organized into at least two levels of chunks.

In some implementations of the method, a chunk of a given level of chunks contains a first pre-defined number of training objects and wherein a chunk of a lower level of chunks contains a different pre-defined number of training objects, the different pre-defined number of training objects being greater than the first pre-defined number of training objects.

In some implementations of the method, a chunk of a given level of chunks contains a first pre-defined number of training objects and wherein a chunk of a lower level of chunks contains the first pre-defined number of training objects and a second set of training objects located sequentially after the first pre-defined number of training objects in the ordered list, a number of training objects within the second set of training objects being the same as the first pre-defined number of training objects.

In some implementations of the method, the calculating the indication of the at least one quality approximation parameter of the given training object generated during the previous iteration of the training of the previous decision tree comprises: for the given training object, calculating at least one quality approximation parameter based on the training objects located in the same chunk as the given training object.

In some implementations of the method, the generating the prediction quality parameter for the given level of a decision tree comprises: using quality approximation parameters of past training objects located in a largest chunk that does not contain the given training object.

In some implementations of the method, the organizing the set of training objects into an ordered list of training objects comprises: generating a plurality of ordered lists of training objects, each of the plurality of ordered lists of training objects being organized such that for each given training object in the ordered list of training objects there is at least one of: (i) a preceding training object that occurs before the given training object and (ii) a subsequent training object that occurs after the given training object; a given one of the plurality of ordered lists of training objects having a least partially different order from others of the plurality of ordered lists of training objects.

In some implementations of the method, the method further comprises selecting the given one of the plurality of ordered lists of training objects.

In some implementations of the method, the selecting is done for each iteration of generating of the prediction quality parameter.

In some implementations of the method, the selecting is done an entirety of a process of verification of prediction quality for a given decision tree.

In some implementations of the method, the set of training objects is associated with an inherent temporal relationship of training objects and wherein the organizing the set of training objects into the ordered list of training objects comprises organizing the set of training objects in accordance with the temporal relationship.

In some implementations of the method, the set of training objects is not associated with an inherent temporal relationship of training objects and wherein the organizing the set of training objects into the ordered list of training objects comprises organizing the set of training objects in accordance with a rule.

In some implementations of the method, the set of training objects is not associated with an inherent temporal relationship of training objects and wherein the organizing the set of training objects into the ordered list of training objects comprises organizing the set of training objects in a randomly generated order.

System Claims

In accordance with another broad aspect of the present technology, there is provided a server configured to execute a Machine Learning Algorithm (MLA), the MLA being based on a decision tree prediction model based on a decision tree, a given level of the decision tree having at least one node. The server is further configured to: access, from a non-transitory computer-readable medium of the server, a set of training objects, each training object of the set of training object containing an indication of a document and a target associated with the document; organize the set of training objects into an ordered list of training objects, the ordered list of training objects is organized such that for each given training object in the ordered list of training objects there is at least one of: (i) a preceding training object that occurs before the given training object and (ii) a subsequent training object that occurs after the given training object; descend the set of training objects through the decision tree so that each one of the set of training objects gets categorized, by the decision tree prediction model at the given iteration of training, into a given child node of the at least one node of the given level of the decision tree; generate a prediction quality parameter for the given level of a decision tree, the prediction quality parameter being for evaluating prediction quality of the decision tree prediction model at a given iteration of training of the decision tree, by: generating, for a given training object that has been categorized into the given child node, a prediction quality parameter, the generating being executed based on targets of only those training objects that occur before the given training object in the ordered list of training objects.

In accordance with another broad aspect of the present technology, there is provided a server configured to execute a Machine Learning Algorithm (MLA), the MLA being based on a decision tree prediction model based on a decision tree, a given level of the decision tree having at least one node. The server is further configured to: access, from a non-transitory computer-readable medium of the machine learning system, a set of training objects, each training object of the set of training object containing an indication of a document and a target associated with the document; organize the set of training objects into an ordered list of training objects, the ordered list of training objects is organized such that for each given training object in the ordered list of training objects there is at least one of: (i) a preceding training object that occurs before the given training object and (ii) a subsequent training object that occurs after the given training object; descend the set of training objects through the decision tree so that each one of the set of training objects gets categorized, by the decision tree model at the given iteration of training, into a given child node of the at least one node of the given level of the decision tree; generate a prediction quality parameter for the given level of a decision tree, the prediction quality parameter being for evaluating prediction quality of the decision tree prediction model at a given iteration of training of the decision tree, the given iteration of training of the decision tree having at least one previous iteration of training of a previous decision tree, the decision tree and the previous decision tree forming an ensemble of tree generated using a decision tree boosting technique, by: generating, for a given training object that has been categorized into the given child node, a prediction quality approximation parameter, the generating being executed based on: targets of only those training objects that occur before the given training object in the ordered list of training objects; and at least one prediction quality approximation parameter of the given training object generated during the previous iteration of the training of the previous decision tree.

In accordance with yet another broad aspect of the present technology, there is provided a method of determining a prediction quality parameter for a decision tree prediction model, a given level of the decision tree having at least one node, the prediction quality parameter being for evaluating prediction quality of the decision tree prediction model at a given iteration of training of the decision tree, the given iteration of training of the decision tree having at least one previous iteration of training of a previous decision tree, the decision tree and the previous decision tree forming an ensemble of tree generated using a decision tree boosting technique. The method is executable at a machine learning system that executes the decision tree prediction model. The method comprises: accessing, from a non-transitory computer-readable medium of the machine learning system, a set of training objects, each training object of the set of training object containing an indication of a document and a target associated with the document; organizing the set of training objects into an ordered list of training objects, the ordered list of training objects is organized such that for each given training object in the ordered list of training objects there is at least one of: (i) a preceding training object that occurs before the given training object and (ii) a subsequent training object that occurs after the given training object; descending the set of training objects through the decision tree so that each one of the set of training objects gets categorized, by the decision tree model at the given iteration of training, into a given child node of the at least one node of the given level of the decision tree; generating the prediction quality parameter for the given level of a decision tree by: generating, for a given training object that has been categorized into the given child node, a prediction quality approximation parameter, the generating being executed based on: targets of only those training objects that occur before the given training object in the ordered list of training objects; and at least one prediction quality approximation parameter of the given training object generated during the previous iteration of the training of the previous decision tree; calculating an indication of the at least one quality approximation parameter of the given training object generated during the at least one previous iteration of the training of the previous decision tree by splitting the ordered list of training objects into a plurality of chunks, the plurality of chunks being organized into at least two levels of chunks.

The present technology thereby results, amongst other benefits, in a more accurate level of prediction of the machine-learning model allowing a computer-implemented system to (1) improve usage of computing processing power; and (2) deliver to an end user more relevant predictions.

In the context of the present specification, unless expressly provided otherwise, an “electronic device”, an “electronic device”, a “server”, a, “remote server”, and a “computer-based system” are any hardware and/or software appropriate to the relevant task at hand. Thus, some non-limiting examples of hardware and/or software include computers (servers, desktops, laptops, netbooks, etc.), smartphones, tablets, network equipment (routers, switches, gateways, etc.) and/or combination thereof.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein. Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a table storing prediction results for each of the training objects x used for generating and/or validating decision trees of a decision tree model used by a Machine Learning Algorithm in accordance with non-limiting embodiments of the present technology.

FIG. 2 depicted a schematic illustration of a “quadratic explosion” that may occur during calculations of approximations for decision trees during boosting of decision trees.

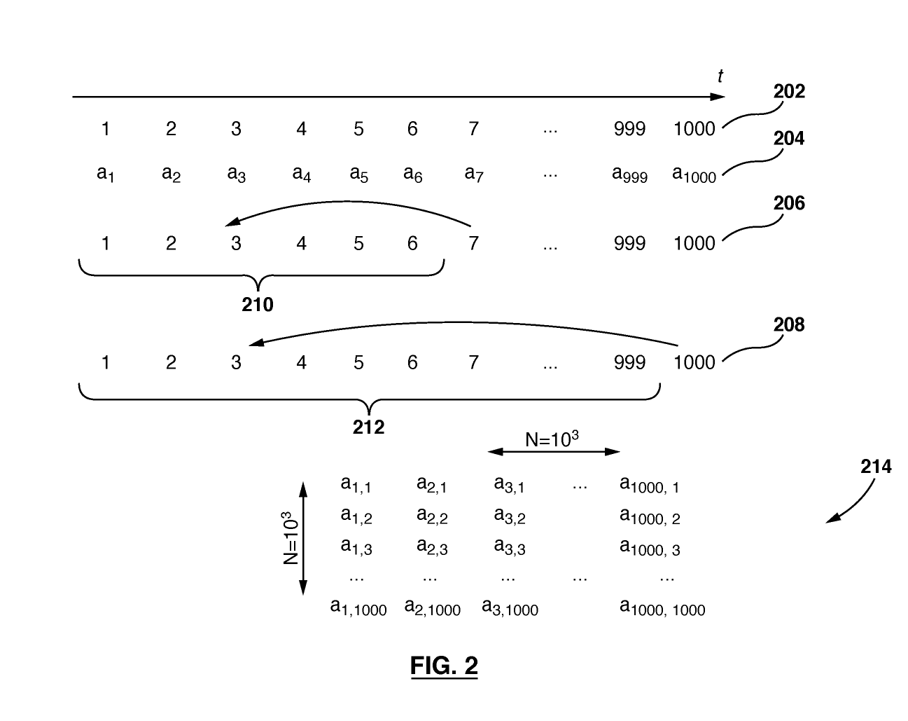

FIG. 3 depicts an ordered list of training objects generated by the MLA in accordance with non-limiting embodiments of the present technology.

FIG. 4 is a diagram of a computer system suitable for implementing the present technology and/or being used in conjunction with implementations of the present technology.

FIG. 5 is a diagram of a networked computing environment in accordance with an embodiment of the present technology.

FIG. 6 is a diagram illustrating a partial tree model and two exemplary feature vectors in accordance with an embodiment of the present technology.

FIG. 7 is a diagram illustrating a complete tree model in accordance with an embodiment of the present technology.

FIG. 8 is a diagram illustrating portions of a preliminary tree model and a complete preliminary tree model in accordance with another embodiment of the present technology.

FIG. 9 is a diagram illustrating portions of preliminary tree models in accordance with another embodiment of the present technology.

FIG. 10 is a diagram illustrating complete preliminary tree models in accordance with another embodiment of the present technology.

FIG. 11 is a diagram illustrating a portion of a proto-tree with a single first level node and two instances of a second level node, as well as an ordered list of training objects generated in accordance with another embodiments of the present technology.

FIG. 12 is a diagram illustrating a flowchart illustrating a first computer-implemented method implementing embodiments of the present technology.

FIG. 13 is a diagram illustrating a flowchart illustrating a second computer-implemented method implementing embodiments of the present technology.

It should also be noted that, unless otherwise explicitly specified herein, the drawings are not to scale.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the Figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

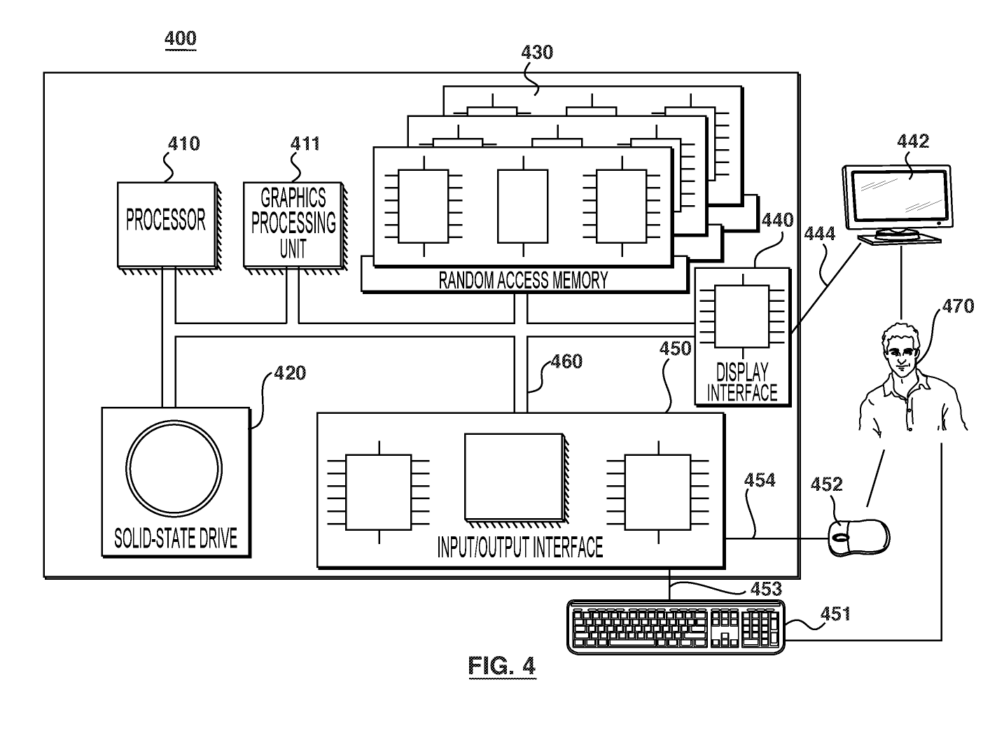

Referring to FIG. 4, there is shown a computer system 400 suitable for use with some implementations of the present technology, the computer system 400 comprising various hardware components including one or more single or multi-core processors collectively represented by processor 410, a graphics processing unit (GPU) 411, a solid-state drive 420, a random access memory 430, a display interface 440, and an input/output interface 450.

Communication between the various components of the computer system 400 may be enabled by one or more internal and/or external buses 460 (e.g. a PCI bus, universal serial bus, IEEE 1394 “Firewire” bus, SCSI bus, Serial-ATA bus, etc.), to which the various hardware components are electronically coupled. The display interface 440 may be coupled to a monitor 442 (e.g. via an HDMI cable 144) visible to a user 470, and the input/output interface 450 may be coupled to a touchscreen (not shown), a keyboard 451 (e.g. via a USB cable 453) and a mouse 452 (e.g. via a USB cable 454), each of the keyboard 451 and the mouse 452 being operable by a user 470.

According to implementations of the present technology, the solid-state drive 420 stores program instructions suitable for being loaded into the random access memory 130 and executed by the processor 410 and/or the GPU 411 for processing activity indications associated with a user. For example, the program instructions may be part of a library or an application.

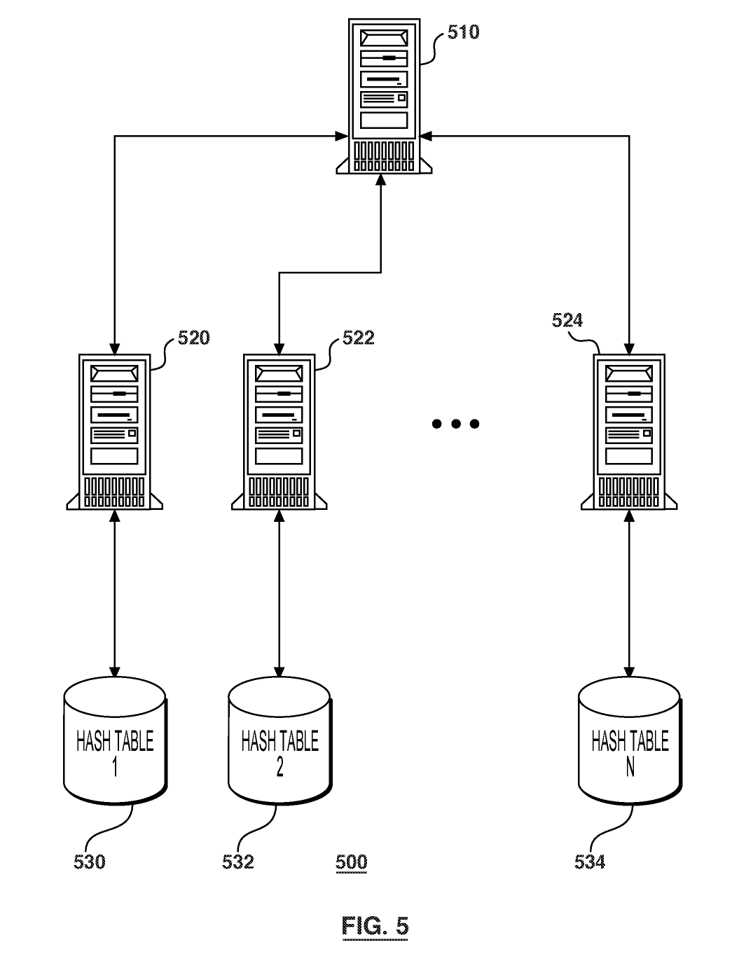

In FIG. 5, there is shown a networked computing environment 500 suitable for use with some implementations of the present technology, the networked computing environment 500 comprising a master server 510 in communication with a first slave server 520, a second slave server 522 and a third slave server 524 (also referred to as the slave servers 520, 522, 524 hereinafter) via a network (not depicted) enabling these systems to communicate. In some non-limiting embodiments of the present technology, the network can be implemented as the Internet. In other embodiments of the present technology, the network may be implemented differently, such as any wide-area communications network, local-area communications network, a private communications network and the like.

The networked computing environment 500 may contain more or fewer slave servers without departing from the scope of the present technology. In some embodiments, no “master server-slave server” configuration may be required, a single server may be sufficient. The number of servers and the type of architecture is therefore not limitative to the scope of the present technology. The master server-slave server architecture depicted in FIG. 5 is particularly useful (but not so limited) in those scenarios, where it is desirable to have parallel processing of some or all routines that will be described below.

In one embodiment, a communication channel (not depicted) between the master server 510 and the slave servers 520, 522, 524 may be established to allow data exchange. Such data exchange may occur on a continuous basis or, alternatively, upon occurrence of certain events. For example, in the context of crawling webpages and/or processing a search query, a data exchange may occur as a result of the master server 510 overseeing the training of machine-learning models by the networked computing environment.

In some embodiments, the master server 510 may receive a set of training objects and/or a set of testing objects and/or a set of features from a frontend search engine server (not depicted) and send the set of training objects and/or the set of testing objects and/or the set of features to one or more of the slave servers 520, 522, 524. Once received from the master server 510, the one or more slave servers 520, 522, 524 may process the set of training objects and/or the set of test objects and/or the set of features in accordance with the non-limiting embodiments of the present technology to generate one or more machine-learning models, each one of the machine-learning models comprising, in some instances, one or more tree models. In some embodiments, the one or more tree models model an association between the document and the target (the target can be a parameter of interest, a relevancy score, etc.).

A generated machine-learning model may be transmitted to the master server 510 so that the master server 510 may generate a prediction, for example in the context of a search query received from the frontend search engine server, based on the search query received from an electronic device associated with a user wishing to execute a computer-based search. Upon applying the generated machine-learning model to the search query, the master server 510 may transmit one or more corresponding results to the frontend search engine server. In some alternative embodiments, the one or more slave servers 520, 522, 524 may directly host the generated machine-learning model and process the search query received from the frontend search engine server through the master server 510 or directly from the frontend search engine.

The master server 510 can be implemented as a conventional computer server and may comprise some or all of the features of the computer system 400 depicted at FIG. 4. In an example of an embodiment of the present technology, the master server 510 can be implemented as a Dell™ PowerEdge™ Server running the Microsoft™ Windows Server™ operating system. Needless to say, the master server 510 can be implemented in any other suitable hardware and/or software and/or firmware or a combination thereof. In the depicted non-limiting embodiment of present technology, the master server 510 is a single server. In alternative non-limiting embodiments of the present technology, the functionality of the master server 210 may be distributed and may be implemented via multiple servers.

The implementation of the master server 510 is well known to the person skilled in the art of the present technology. However, briefly speaking, the master server 510 comprises a communication interface (not depicted) structured and configured to communicate with various entities (such as the frontend search engine server and/or the slave servers 520, 522, 524, for example and other devices potentially coupled to the network) via the network. The master server 510 further comprises at least one computer processor (e.g., a processor 410 of the master server 510) operationally connected with the communication interface and structured and configured to execute various processes to be described herein.

The general purpose of the master server 510 is to coordinate the generation of machine-learning models by the slave servers 520, 522, 524. As previously described, in an embodiment, the set of training objects and/or the set of testing objects and/or the set of features may be transmitted to some or all of the slave servers 520, 522, 524 so that the slave servers 520, 522, 524 may generate one or more machine-learning models based on the set of training objects and/or the set of testing objects and/or the set of features. In some embodiments, a machine-learning model may comprise one or more tree models. Each one of the tree models may be hosted on one of the slave servers 520, 522, 524. In some alternative embodiments, the tree models may be hosted on at least two of the slave servers 520, 522, 524. As a person skilled in the art of the present technology will appreciate, where the machine-learning model and/or the tree models forming the machine-learning model are hosted is not critical to the present technology and many variations may be envisioned without departing from the scope of the present technology.

In some embodiments, once the slave servers 520, 522, 224 host the one or more generated machine-learning model, the slave servers 520, 522, 524 may receive instructions to conduct associations between a document and a target, the document being a different object from the training objects of the set of training objects and comprising a set of features corresponding to values associated with some features selected from the set of features defining a structure of at least one of the tree model.

Once the association between the document and the target has been completed by the slave servers 520, 522, 524, the master server 510 may receive, from the slave servers 520, 522, 524, the target to be associated with the document. In some other embodiments, the master server 510 may be limited to sending a document and/or the set of features associated with the document without receiving any target in return. This scenario may occur upon determination by one or more of the slave servers 520, 522, 524 that the document and/or the set of features associated with the document leads to modification of one of the tree models hosted on the slave servers 520, 522, 524.

In some embodiments, the master server 510 may comprise logic which may generate instructions to modify the one or more tree models hosted at the slave servers 520, 522, 524 along with a target to be associated with the document. In such instances, one of the tree models hosted by the slave servers 520, 522, 524 may be modified so that the document may be associated with the target in the tree model. In some embodiments, once one of the tree models hosted by the slave servers 520, 522, 524 has been modified, the slave servers 520, 522, 524 may transmit a message to the master server 510, the message being indicative of a modification made to one of the tree models. Other variations as how the master server 510 interacts with the slave servers 520, 522, 524 may be envisioned without departing from the scope of the present technology and may become apparent to the person skilled in the art of the present technology. In addition, it should be also expressly understood that in order to simplify the description presented herein above, the configuration of the master server 510 has been greatly simplified. It is believed that those skilled in the art will be able to appreciate implementational details for the master server 510 and for components thereof that may have been omitted for the purposes of simplification of the description.

The slave servers 520, 522, 524 can be implemented as conventional computer servers and may comprise some or all of the features of the computer system 400 depicted at FIG. 4. In an example of an embodiment of the present technology, the slave servers 520, 522, 524 can be implemented as a Dell™ PowerEdge™ Server running the Microsoft™ Windows Server™ operating system. Needless to say, the slave servers 520, 522, 524 can be implemented in any other suitable hardware and/or software and/or firmware or a combination thereof. In the depicted non-limiting embodiment of present technology, the slave servers 520, 522, 524 operate on a distributed architecture basis. In alternative non-limiting embodiments, a single slave server may be relied upon to operate the present technology.

The implementation of the slave servers 520, 522, 524 is well known to the person skilled in the art of the present technology. However, briefly speaking, each one of the slave servers 520, 522, 524 may comprise a communication interface (not depicted) structured and configured to communicate with various entities (such as the frontend search engine server and/or the master server 510, for example and other devices potentially coupled to the network) via the network. Each one of the slave servers 520, 522, 524 further comprises at least one computer processor (e.g., similar to the processor 410 depicted at FIG. 4) operationally connected with the communication interface and structured and configured to execute various processes to be described herein. Each one of the slave servers 520, 522, 524 further may comprise one or more memories (e.g., similar to the solid-state drive 420 and/or the random access memory 430 depicted at FIG. 4).

The general purpose of the slave servers 520, 522, 524 is to generate the one or more machine-learning models. As previously described, in an embodiment, the machine-learning models may comprise one or more tree models. Each one of the tree models comprises a set of features (which may also be referred to as a subset of features if the features forming the subset has been selected from a set of features). Each feature of the set of features corresponds to one or more nodes of a corresponding tree model.

During the generation of the one or more machine-learning models, the slave servers 520, 522, 524 may rely on the set of training objects and/or the set of testing objects to select and organise the features so as to generate a tree model. This process of selecting and organizing the features may be repeated throughout multiple iterations so that the slave servers 520, 522, 524 generate multiple tree models, each one of the tree models corresponding to a different selection and/or organization of the features. In some embodiments, the set of training objects and/or the set of testing objects and/or the set of features may be received from the master server 510 and/or the frontend server. Once the machine-learning models have been generated, the slave servers 520, 522, 524 may transmit to the master server 510 an indication that the machine-learning models have been generated and may be relied upon to generate predictions, for example, but without being limitative, in the context of classifying documents during a “web crawling” process and/or upon processing a search query received from through the frontend search engine server and/or for generating personalized content recommendations.

In some embodiments, the slave servers 520, 522, 524 may also receive a document and a set of features associated with the document along with a target to be associated with the document. In some other embodiments, the slave servers 520, 522, 524 may not transmit any target to the master server 510. This scenario may occur upon determination by the slave servers 520, 522, 524 that the target to be associated with the document leads to a modification of one of the tree models that they host.

In some embodiments, once one of the tree models hosted by the slave servers 520, 522, 524 has been modified, the slave servers 520, 522, 524 may transmit a message to the master server 510, the message being indicative of a modification made to one of the tree models. Other variations as how the slave servers 520, 522, 524 interact with the master server 510 may be envisioned without departing from the scope of the present technology and may become apparent to the person skilled in the art of the present technology. In addition, it should be also expressly understood that in order to simplify the description presented herein above, the configuration of the slave servers 520, 522, 524 has been greatly simplified. It is believed that those skilled in the art will be able to appreciate implementational details for the slave servers 520, 522, 524 and for components thereof that may have been omitted for the purposes of simplification of the description.

Still referring to FIG. 5, the slave servers 520, 522, 524 may each be communicatively coupled to, respectively, a “hash table 1” database 530, a “hash table 2” database 532 and a “hash table n” database 534 (referred to as “the databases 530, 532, 534” hereinafter). The databases 530, 532, 534 may be part of the slave servers 520, 522, 524 (e.g., stored in the memories of the slave servers 520, 522, 524 such as the solid-state drive 420 and/or the random access memory 430) or be hosted on distinct database servers. In some embodiments, a single database accessed by the slave servers 520, 522, 524 may be sufficient. The number of databases and the arrangement of the databases 530, 532, 534 are therefore not limitative to the scope of the present technology. The databases 530, 532, 534 may be used to access and/or store data relating to one or more hash tables representative of machine-learning models such as, but without being limited thereto, tree models generated in accordance with the present technology.

In some embodiments of the present technology, each one of the databases 530, 532, 534 stores the same set of information (i.e. the same information is stored on all of the databases 530, 532, 534). For example, each of the databases 530, 532, 534 can store the same set of training objects. This is particularly useful (but not so limited) in those embodiments of the present technology, where the arrangement of the master server 510 and the slave servers 520, 522, 524 is used for parallel processing and building of the decision trees. In this arrangement, each of the slave server 520, 522, 524 has access to the same set of training objects.

In some embodiments, the databases 530, 532, 534 may be accessed by the slave servers 520, 522, 524 to identify a target to be associated with the document further to the processing of set of features associated with the document by the slave servers 520, 522, 524 in accordance with the present technology. In some other embodiments, the databases 530, 532, 534 may be accessed by the slave servers 520, 522, 524 to store a new entry (also referred to as a “hashed complex vector” and/or “key” hereinafter) in the one or more hash tables, the new entry having been generated further to the processing of the set of features associated with the document and being representative of a target to be associated with the document. In such embodiments, the new entry may be representative a modification made to a tree models model by the hash table. Even though FIG. 5 illustrates an embodiment wherein the databases 530, 532, 534 comprise hash tables, it should be understood that alternative embodiments as to how machine-learning models may be stored may be envisioned without departing from the scope of the present technology.

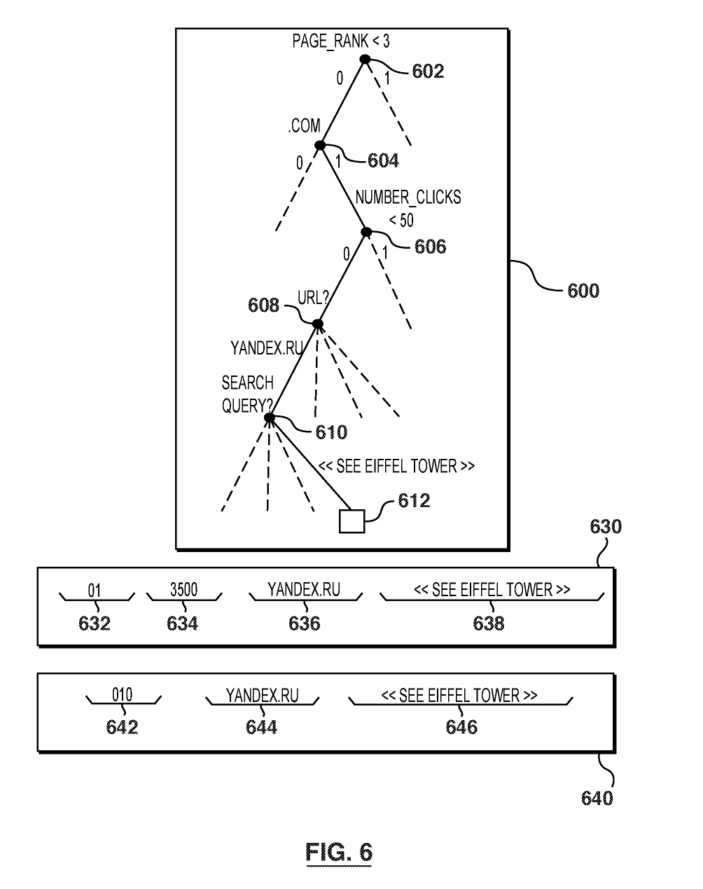

We will now turn out attention to how the tree models forming a machine-learning model are processed will be provided in connection with the description of FIGS. 6 to 8.

Turning now to FIG. 6, a partial tree model 600, a first set of features 630 and a second set of features 640 are depicted. The first set of features 630 and the second set of features 640 may equally be referred to as feature vectors. The partial tree model 600 may have been generated in accordance with the present technology and may model an association between a document and a target. The tree model 600 may be referred to as a machine-learning model or a portion of a machine-learning model (e.g., for implementations wherein the machine-learning model relies on multiple tree models). In some instances, the tree model 600 may be referred as a prediction model or a portion of a prediction model (e.g., for implementations wherein the prediction model relies on multiple tree models).

The document may take multiple forms and formats to represent documents of various natures, such as, but without being limitative, text files, text documents, web pages, audio files, video files and so on. The document may equally be referred to as a file without departing from the scope of the present technology. In an embodiment, the file may be a document searchable by a search engines. However, multiple embodiments may be envisioned without departing from the scope of the present technology and may become apparent to the person skilled in the art of the present technology.

As previously discussed, the target may take multiple forms and formats to represent an indication of an order or ranking of a document such as a “click-through rate (CTR)”, for example, but without being limitative. In some embodiments, the target may be referred to as a label and/or a ranking, in particular in the context of search engines. In some embodiments, the target may be generated by a machine-learning algorithm using a training document. In some alternative embodiments, other methods may be used such as, but without being limitative manually defining the target. How the target is generated is therefore not limitative and multiple embodiments may be envisioned without departing from the scope of the present technology and may become apparent to the person skilled in the art of the present technology.

A path throughout the partial tree model 600 may be defined by the first set of features 630 and/or the second set of features 640. The first set of features 630 and the second set of features 640 may be associated with a same document or with different documents. The partial tree model 600 comprises multiple nodes each connected to one or more branches. In the embodiment depicted at FIG. 6, a first node 602, a second node 604, a third node 606, a fourth node 608 and a fifth node 610 are depicted.

Each one of the first node 602, the second node 604, the third node 606, the fourth node 608 and the fifth node 610 is associated with a condition thereby defining a so-called split.

The first node 602 is associated with a condition “if Page_rank<3” associated with two branches (i.e., true represented by a binary number “0” and false represented by a binary number “1”), the second node 604 is associated with a condition “Is main page?” associated with two branches (i.e., true represented by a binary number “0” and false represented by a binary number “1”), the third node 606 is associated with a condition “if Number_clicks<5,000” associated with two branches (i.e., true represented by a binary number “0” and false represented by a binary number “1”), the fourth node 608 is associated with a condition “which URL?” associated with more than two branches (i.e., each one of the branches is associated with a different URL, for example, the URL “yandex.ru”) and the fifth node 610 is associated with a condition “which Search query?” associated with more than two branches (i.e., each one of the branches is associated with a different search query, for example, the search query “See Eiffel Tower”).

In an embodiment, each one of the conditions set forth above may define a distinct feature (i.e., the first node 602 is defined by the condition “if Page_rank<3”, the second node 604 is defined by the condition “Is main page?”, the third node 606 is defined by the condition “if Number_clicks<5,000”, the fourth node 608 is defined by the condition “which URL?” and the fifth node 610 is defined by the condition “which Search query?”). In addition, the fifth node 610, via the branch “See Eiffel Tower” is associated with a leaf 612. In some embodiments, the leaf 612 may be indicative of a target.

As a result of the above-described configuration, the tree model 600 defined by the specific selection and organisation of the first node 602, the second node 604, the third node 606, the fourth node 608 and the fifth node 610 may be used to associate a document (such as, for example, but without being limitative, a web page in the html format) with the target associated with the leaf 612, the association being defined by a path through the partial tree model 300 based on the first set of features 630 and/or the second set of features 640.

It should be appreciated that for purpose of clarity, the partial tree model 600 only represents a portion of a complete tree model. The person skilled in the art of the present technology may appreciate that the number of nodes, branches and leafs is virtually unlimited and solely depends on a complexity of the tree model to be built. In addition, in some embodiments, the tree model may be a pure binary—comprising a set of nodes each comprising only two branches (i.e., true represented by a binary number “0” and false represented by a binary number “1”).

However, the present technology is not limited to such tree models and multiple variations may be envisioned by the person skilled in the art of the present technology, such as for example, a tree model comprising a first portion defining a binary tree model and a second portion defining a categorical tree model as exemplified by the tree model 600 (e.g., a first portion defined by the first node 602, the second node 604 and the third node 606 and a second portion defined by the fourth node 608 and the fifth node 610).

The first set of features 630 illustrates an example of features defining the path illustrated by the tree model 600. The set of features 630 may be associated with the document and allows defining the path in the tree model 600 described in the paragraph above. At least one of the features of the set of features may be of binary type and/or of real number type (e.g., integer number type, floating number type).

In the example of FIG. 6, the set of features comprises a first component 632 associated with a value “01” and a second component 634 associated with a value “3500”. Even though the term “component” is used in the present description, it should be understood that the term “variable” may be equally used and may therefore be considered as being an equivalent to “component”. The first component 632 comprises the binary sequence “01” which, once projected in the tree model 600, allows establishing a first portion of the path. In the example of FIG. 6, the first portion of the path is established by applying a first binary digit “0” of the sequence “01” to the first node 602 and then a second binary digit “1” of the sequence “01” to the second node 604. The second component 634, once project in the tree model 600, allows establishing a second portion of the path. In the example of FIG. 6, the second portion of the path is established by applying the number “3500” to the third node 606″.

Even though the example of FIG. 6 illustrates the first data as comprising the first component 632 and the second component 634, the number of components and the number of digits comprised by one of the components is not limitative and many variations may be envisioned without departing from the scope of the present technology.

In the example of FIG. 6, the first set of features also comprises a third component 636 associated with a value “yandex.ru” and a fourth component 638 associated with a value “See Eiffel Tower”. The third component 636 and the fourth component 638 may be of category type. In some embodiments, third component 636 and the fourth component 638 may also be referred to as categorical features and may comprise, for example, but without being limitative, a host, an URL, a domain name, an IP address, a search query and/or a key word.

In some embodiments, the third component 636 and the fourth component 638 may be broadly described as comprising label categories allowing categorisation of information. In some embodiments, the third component 636 and the fourth component 638 may take the form of a chain and/or string of characters and/or digits. In yet some embodiments, the third component 636 and the fourth component 638 may comprise a parameter that may take more than two values, as it is the case in the example of FIG. 6 thereby resulting in the tree model 600 having as many branches connected to a given node as a number of possible values of the parameter.

Multiple variations as to what the third component 636 and the fourth component 638 may comprise is not limitative and many variations may be envisioned without departing from the scope of the present technology. In some embodiments, the third component 636 and the fourth component 638 may represent a path in a non-binary portion of the tree model as it is the case in the example depicted at FIG. 6. Other variations may also be possible without departing from the scope of the present technology.

The third component 636 comprises a string of character “yandex.ru” which, once projected in the tree model 600, allows establishing a fourth portion of the path. In the example of FIG. 6, the fourth portion of the path is established by applying the string of character “yandex.ru” to the fourth node 608. The fourth component 638, once projected in the tree model 600, allows establishing a fifth portion of the path. In the example of FIG. 6, the fifth portion of the path is established by applying the string of character “See Eiffel Tower” to the fifth node 610 thereby leading to the leaf 612 and the target associated therewith. Even though the example of FIG. 6 illustrates the third component 636 and the fourth component 638, the number of components and the number of digits and/or characters comprised by one of the components is not limitative and many variations may be envisioned without departing from the scope of the present technology.

Turning now to the second set of features 640, the second set of features 640 illustrates another example of features defining the path illustrated by the tree model 600. As for the first set of features 630, the second set of features 640 may be associated with the document and allows defining the path in the tree model 600 described in the above. The second set of features 640 is similar on all aspects to the first set of features 630 with the exception that the second set of features 640 comprises a first component 642 instead of the first component 632 and the second component 634 of the first set of features 630.

The first component 642 comprises a sequence of digits “010” whereas the first component 632 is associated with the value “01” and the second component 634 is associated with the value “3500”. As a person skilled in the art of the present technology may appreciate, in the first component 642, the value “3500” has been represented by a binary digit “0” which is the output of the value “3500” applied to the condition associated with the third node 606 (i.e., Number_clicks<5,000″). As a result, the first component 642 may be considered as an alternative representation to the first component 632 and the second component 634 of a same path in the tree model 600.

As a result, in some embodiments, a real number value may be translated into a binary value in particular for cases where a node of a tree model to which the integer value is to be applied corresponds to a binary section of the tree model. Other variations may also be possible and the example of the second set of features 640 should not be construed as being limitative of the scope of the present technology. The second set of features 640 also comprise a second component 644 and a third component 646 that are identical to the third component 636 and the fourth component 638 of the first set of features 630.

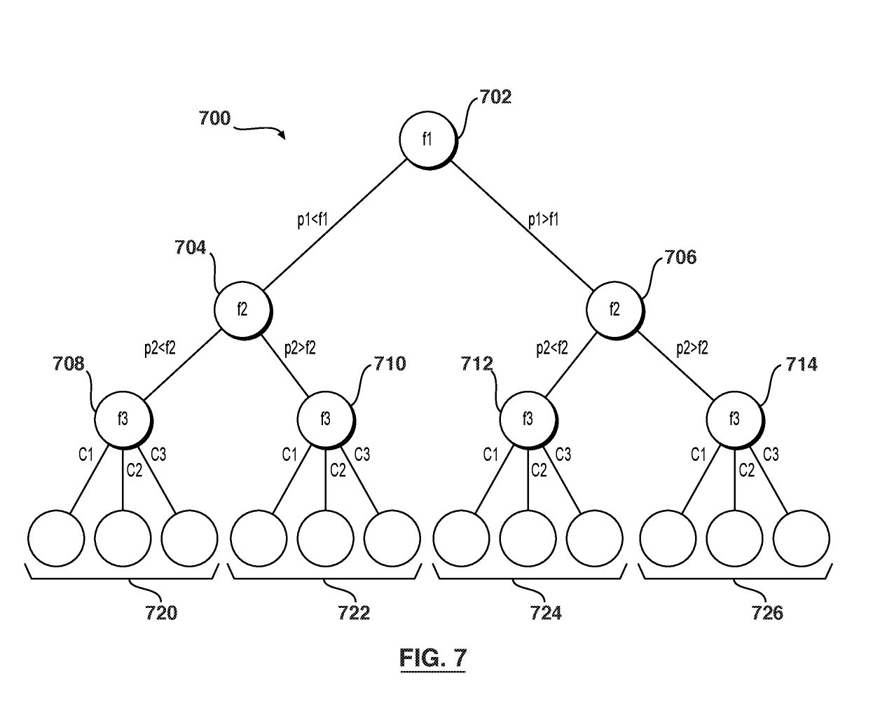

Turning now to FIG. 7, an example of a complete tree model 700 is depicted. The tree model 700 aims at illustrating a generic tree model which may be modified so as to meet the requirements of a specific prediction model. Such modifications may include, for example but without being limitative, adding or removing one or more level of the tree, adding or removing nodes (i.e., features and the associated splits), adding or removing branches connecting the nodes and/or the leafs of the tree.

The tree model 700 may be part of a machine-learning model or be the machine-learning model. The tree model 700 may be a preliminary tree model or a trained tree model. In some embodiments, the tree model 700 may, once generated, be updated and/or modified to improve, for example, a level of accuracy of the machine-learning model and/or a scope of application of the machine-learning model. In some embodiments, the tree model 700 may be relied upon to process, for example, but without being limited to, search engine requests or personalized content recommendations. Other fields in which the tree model 700 may be relied upon may also be envisioned without departing from the scope of the present technology.

The tree model 700 comprises a first node 702 associated with a first feature “f1”. The first node 702 defines a first level of the model tree 700. The first node 702 is connected through branches to a second node 704 and a third node 706. The second node 704 and the third node 706 are both associated with a second feature “f2”. The second node 704 and the third node 706 define a second level of the tree model 700. In an embodiment, the first feature “f1” and the split for the first feature “f1” have been selected amongst a set of features to be positioned at a first level of the model tree 700 on the basis of a set of training objects. More details regarding how the selection of the features from a set of features and the associated splits is made will be provided in the sections below.

The first feature “f1” is defined so that, for a given object, a value of a parameter associated with the first feature “f1” determines whether the object is to be associated with the second node 704 or the third node 706. As an example, if the value is less than a value “f1” then the object is associated with the second node 704. As another example, if the value is more than the value “f1” then the object is associated with the third node 706.

In turn, the second node 704 is associated with a fourth node 708 associated with a third feature “f3” and a fifth node 710 associated with the third feature “f3”. The third node 706 is associated with a sixth node 712 associated with the third feature “f3” and a seventh node 714 associated with the third feature “f3”. The fourth node 708, the fifth node 710, the sixth node 712 and the seventh node 714 define a third level of the tree model 700. As previously described in connection with the first node 702, for a given object, a value of a parameter associated with the second feature “f2” determines whether the object is to be associated with the fourth node 708 or the fifth node 710 (if the object is associated with the second node 704) or the sixth node 712 or the seventh node 714 (if the object is associated with the third node 706).

In turn, each one of the fourth node 708, the fifth node 710, the sixth node 712 and the seventh node 714 are associated with sets of predicted parameters. In the example illustrated at FIG. 7, the sets of predicted parameters comprise a first set 720, a second set 722, a third set 724 and a fourth set 726. Each one of the sets of predicted parameters comprises three targets, namely “C1”, “C2” and “C3”.

As a person skilled in the art of the present technology may appreciate, the tree model 700 illustrates an embodiment wherein a particular level of the tree model 700 is associated with one feature. In the example of FIG. 7, a first level comprises the first node 702 and is associated with the first feature “f1”; a second level comprises the second node 704 and the third node 706 and is associated with the second feature “f2”; and a third level comprises the fourth node 708, the fifth node 710, the sixth node 712 and the seventh node 714 and is associated with the third feature “f3”.

In other words, in the embodiment of FIG. 7, the first level is associated with the first feature “f1”, the second level is associated with the second feature “f2” and the third level is associated with the third feature “f3”. Other embodiments may however be envisioned. In particular, an alternative embodiment wherein a generated tree model may include distinct features for a given level of the tree model. For example, a first level of such tree model may comprise a first node associated with a first feature “f1”, a second level may comprise a second node associated with a second feature “f2” and a third node associated with a third feature “f3”. As a person skilled in the art of the present technology may appreciate, other variations as to which features may be associated with a given level may be envisioned without departing from the scope of the present technology.

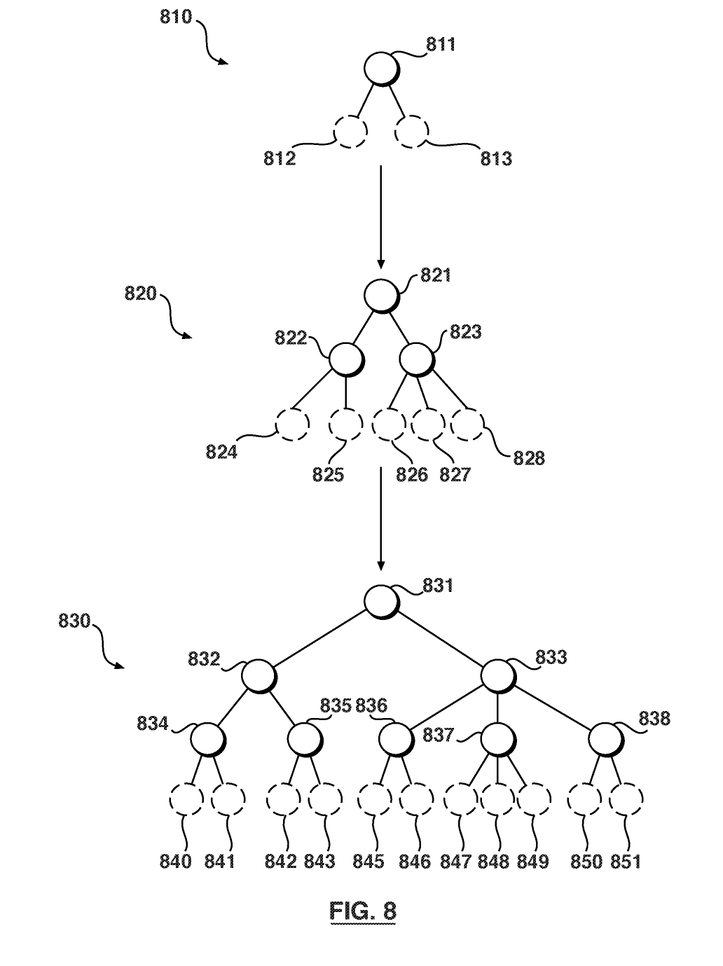

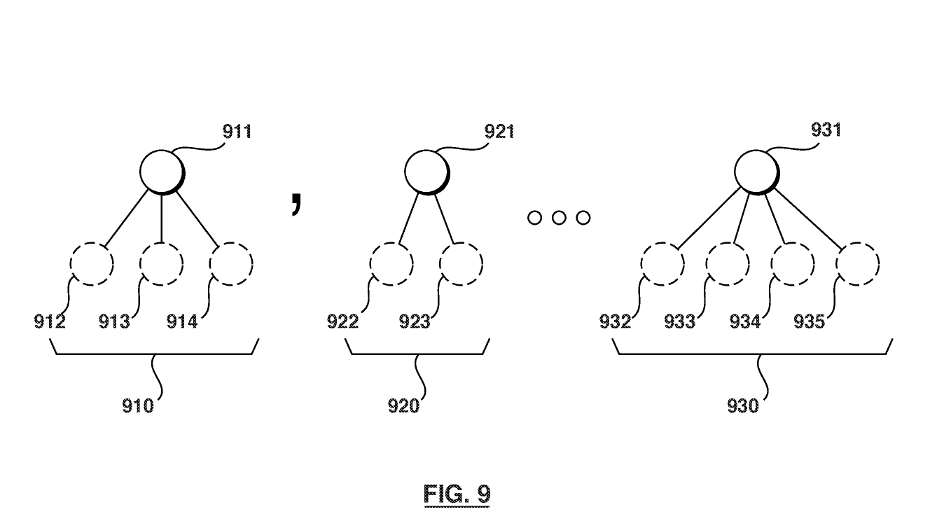

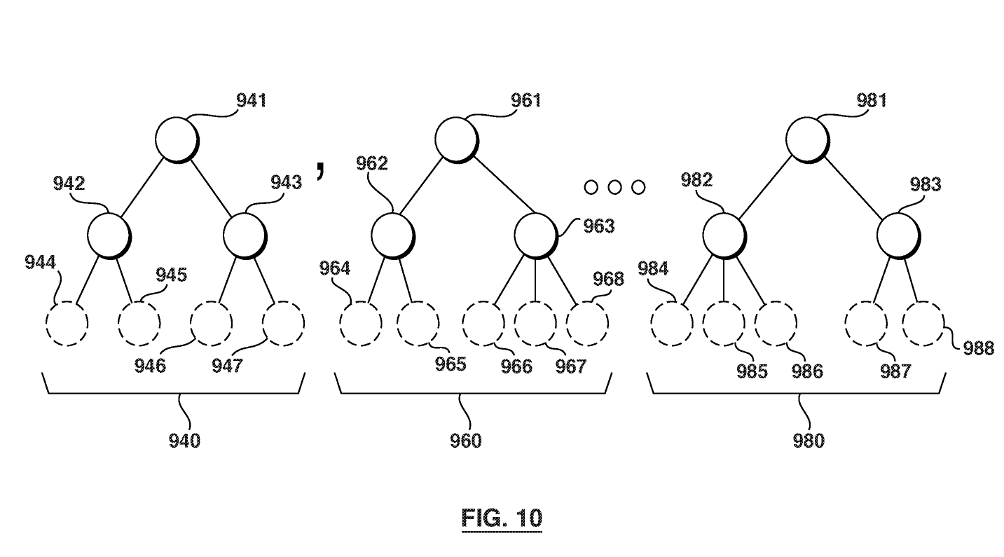

The relevant steps taken to build an embodiment of a trained decision tree prediction model (also referred to as a “trained decision tree”, “tree model” and/or a “tree decision model”) will be discussed with respect to FIG. 8, FIG. 9 and FIG. 10.

FIG. 8 illustrates steps in the generation of an embodiment of the trained decision tree prediction model. FIG. 9 and FIG. 10 illustrate sets of proto-trees (also referred to as “preliminary tree models” or “preliminary decision tree prediction models”) used for choosing a first feature and a second feature features to be used in an embodiment of the trained decision tree prediction model.

It should be noted that the term “proto-tree” is used broadly herein. In some embodiments of the present technology, the term “proto-tree” is used to describe a partially built/partially trained decision tree, for example, as the decision tree is built “level by level”. In other embodiments of the present technology, the term “proto-tree” is used to describe a trained decision tree within an ensemble of decision trees, as the ensemble of decision trees is being built in accordance with the gradient boosting techniques, for example.

In FIG. 8, a progression of building the trained decision tree prediction model based on a set of objects is illustrated. It should be noted that the following description of the trained decision tree prediction model as presented in FIG. 8 is only one non-limiting embodiment of the trained decision tree prediction model and it is contemplated that other non-limiting embodiments may have more or fewer nodes, features, levels and leaves.

Illustrated by a first decision tree 810, the trained decision tree prediction model generation begins by choosing a first feature, associated here with a first node 811. The method by which the features at each level are chosen will be discussed in more detail below.

There are two leaves 812 and 813 at the end of the paths of the first decision tree 810 branching from the first node 811. Each of the leaves 812 and 813 has “leaf values” which are associated with a predicted value of the target at the given level of building of the decision tree. In some embodiments, the first feature “f1” has been selected for the first level node 811 of the decision tree 810 on the basis of the set of training objects based on a leaf accuracy parameter and/or an accuracy parameter of the decision tree 810. The leaf accuracy parameter and/or an accuracy parameter of the decision tree 810 is calculated by means of determining a prediction quality parameter, as will be discussed in greater detail herein below.

More specifically, the first feature “f1” and the associated split have been selected from all possible features and all possible associated splits based on the so-generated prediction quality parameter.

A second feature “f2” is next chosen and added to the decision tree 810, producing a decision tree 820. A second node 822 and a third node 823 associated with the second feature are added to the two branches extended from the first node 811. In an alternative embodiment, the second node 822 and the third node 823 may be associated with distinct features.

In the embodiments illustrated at FIG. 8, the first node 811 remains the same in the decision tree 820 as in the decision tree 810, because the first feature was chosen and fixed at the first level and associated with the first node 811 (based on the gradient boosting approach).

Leaves 824 to 828 are now associated with ends of paths of the decision tree 820. The second node 822 has two leaves, a leaf 824 and a leaf 825, branching from the second node 822. The third node 823 has three leaves, a leaf 826, a leaf 827 and a leaf 828 branching from the third node 823. The numbers of leaves branching from any given node may depend, for example, on features chosen at any given node and features of the training objects upon which the model tree is generated.

Just like with the first feature “f1” a prediction quality parameter is used to select the second feature “f2” and the associated splits for the second node 822 and the third node 823.

As also illustrated in FIG. 8, a third feature “f3” is then chosen and added to the decision tree 820, producing a decision tree 830. The first node 811, the second node 822 and the third node 823 remain the same as they are in the decision tree 810 and the decision tree 820. The first feature and the second feature (and their associated splits) also remain the same as they have been previously chosen and fixed.

New nodes 834-838 are added to branches descending from the second node 822 and the third node 823. New leaves 840-851, associated with ends of paths of the decision tree 830, branch from the new nodes 834-838. Each one of the new leaves 840-851 has a corresponding leaf value associated with one or more predicted values. In this example embodiment, three features have been chosen during the generation of the trained decision tree prediction model. It is contemplated that different embodiments of trained decision tree prediction models could have more or fewer than three features. It should be appreciated that the tree model under generation may have more or fewer than three levels constructed in the above described way.

The manner in which the features are chosen for a trained decision tree prediction model, such as that illustrated in FIG. 7 and FIG. 8, will now be discussed with respect to FIG. 9 and FIG. 10.

In order to choose a “best” feature for the first feature, a set of “proto-trees” having a first node are created. In FIG. 9, three proto-trees 910, 920 and 930 are illustrated as representative samples from the set of proto-trees. In each different one of the proto-trees 910, 920 and 930, a first node is associated with a different feature from the set of available features. For example, a node 911 from the proto-tree 910 is associated with one of the features, “fa”, while a node 921 of the proto-tree 920 is associated with the feature “fb” and while a node 931 of the proto-tree 930 is associated with the feature “fn”. In some embodiments, there is one proto-tree created for each of the features from which the first level feature is to be chosen. Each proto-tree is a different decision tree, although they may be discarded after selection of the best feature to use at the first level node.

In some implementations of the present technology, features such as the feature “fa”, the feature “fb” and the feature “fn” will be associated with features which are numerical and/or categorical. As such, instead of having two leaves per node as would be the case for a decision tree using only binary, many leaves (and branches to which additional nodes may be added) are possible. For example as illustrated in FIG. 9, the proto-tree 910 comprising the node 911 has branches into three leaves 912-914, while the proto-tree 920 and the proto-tree 930 have two leaves 922, 923 and four leaves 932-935, respectively.

The set of proto-trees of FIG. 9 is then used to select the “best” first feature to add to the trained decision tree prediction model under generation. For each one of the proto-trees, a prediction quality parameter is calculated for at least some of the leaves branching from the one or more nodes.

For example, the prediction quality parameter is determined for the proto-trees 910, 920 and 930. In some embodiments, leaf accuracy features are calculated for at least some of the leaves, for example for the leaves 912, 913, and 914 of the proto-tree 910. In some embodiments, the leaf accuracy features may be combined to determine the accuracy parameter. More details as to how the prediction quality parameter are determined will be detailed below.

The first feature to be used for the tree model being created may then be chosen by selecting a “best quality” proto-tree based on the prediction quality parameter for each one of the proto-trees. A feature associated with the “best quality” proto-tree is then chosen as the first feature for the trained decision tree prediction model under generation.

For demonstrative purposes, let us choose the proto-tree 920 as being the “best” proto-tree, for example based on a determination that the proto-tree 920 is associated with a highest accuracy parameter. Turning now to FIG. 10, a second set of proto-trees have been created in order to choose a best second level feature to add to the trained decision tree prediction model under generation. The node 921 and its corresponding branches are kept from the proto-tree 920. The rest of the proto-tree 920 and the first set of proto-trees may now be discarded.

The same set of training objects is then used to test a second set of proto-trees comprising the node 921 associated with the “best” first feature (fixed by the above process) and two nodes associated with a second feature, the second feature being a different one of the set of features for each one of the proto-trees.

In this example, there are two second level nodes because there were two branches associated with the node 921. If the “best” proto-tree had been the proto-tree 830 instead, there would be four nodes associated with the four branches emanating from the node 831.

As illustrated in the three representative examples of proto-trees 940, 960 and 980 from the second set of proto-trees shown in FIG. 10, the first node of each proto-tree is the node 921 from the best first proto-tree and there are, added to the two branches emanating from the node 921, two nodes 942, 943 for the proto-tree 940; two nodes 962, 963 for the proto-tree 960 and two nodes 982, 983 for the proto-tree 980. Each one of the ends of the proto-trees 940, 960 and 980 are associated with leaves, leaves 944-647; 964-968 and 984-988, respectively.

A “best” second feature is now chosen in a same way as described above for the “best” first feature, where the proto-tree composed of the first feature and second feature have, a “better quality” (i.e., having a higher prediction quality parameter) than other proto-trees that were not selected. Then, the second feature associated with the second nodes of the proto-tree having the highest prediction quality parameter is chosen as the second feature to be fixed in the trained decision tree prediction model under generation. For example, if the proto-tree 960 is determined to be the proto-tree with a highest prediction quality parameter, the node 962 and the node 963 will be added to the trained decision tree prediction model under generation.

Similarly, if subsequent features and levels are to be added, a new set of proto-trees will be created using the node 921, the node 962 and the node 963, with new nodes added to the five branches emanating from the node 962 and the node 963. The method would be carried on for as many levels and associated features are desired in the trained decision tree prediction model under generation. It is contemplated that the trained decision tree prediction model may have more or fewer than three levels constructed in the above described way.

Once the trained decision tree prediction model is completed, the determination of the prediction quality parameter may also be carried out for the finished prediction model. In some embodiments, a set of trained decision tree prediction models may be relied upon to define a prediction model instead of a single trained decision tree prediction model, each trained decision tree prediction model of the set may have been generated in accordance with the method set forth above. In some embodiments, the features may be selected from a same set of features and a same set of training objects may be used.

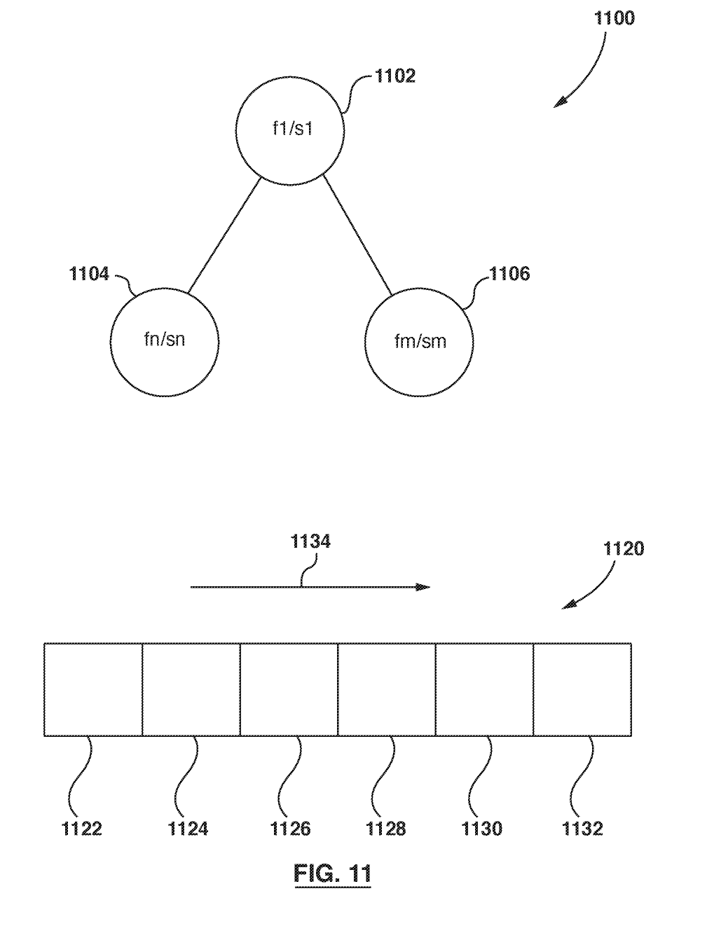

We will now turn our attention to how the prediction quality parameter is generated. With reference to FIG. 11, there is depicted a portion of a proto-tree 1100—with a single first level node (a first node 1102), which can also be considered as a “root node” and two instances of a second level node (a second node 1104 and a third node 1106). For the purposes of the illustration to be presented herein below, it shall be assumed that the value of the feature and the split for the first node 1102 have been selected (f1/s1).

As has been alluded to above, in accordance with the non-limiting embodiments of the present technology, there is provided an ordered list of training objects 1120. In accordance with the non-limiting embodiments of the present technology, the master server 510 and/or the slave servers 520, 522, 524 can generate the ordered list of training objects 1120, as will be described momentarily.

The ordered list of training objects 1120 comprises six training objects—a first training object 1122, a second training object 1114, a third training object 1126, a fourth training object 1128, a fifth training object 1130 and a sixth training object 1132. It should be noted that the nature of the training objects (the first training object 1122, the second training object 1114, the third training object 1126, the fourth training object 1128, the fifth training object 1130 and the sixth training object 1132) is not particularly limited and will depend on the type of prediction the decision tree model is to be used for.

As an example only, if the prediction to be rendered by the decision tree model is a rank (or relevancy) of a particular document relative to a search query, each of the training objects (the first training object 1122, the second training object 1114, the third training object 1126, the fourth training object 1128, the fifth training object 1130 and the sixth training object 1132) may include a pair of a search query and a document, as well as the associated label (the label being indicative of how relevant the document is to the search query). The label may have been provided by a human accessor, as an example only.

The order of the items in the ordered list of training objects 1120 is depicted in FIG. 11 at 1134.

As has been alluded to above, in those embodiments where the training objects (the first training object 1122, the second training object 1114, the third training object 1126, the fourth training object 1128, the fifth training object 1130 and the sixth training object 1132) have an inherent temporal relationship, the order of the items in the ordered list of training objects 1120 is organized in accordance with this temporal relationship between the training objects.

In those embodiments where the training objects (the first training object 1122, the second training object 1114, the third training object 1126, the fourth training object 1128, the fifth training object 1130 and the sixth training object 1132) do not have the inherent temporal relationship, the order of the items in the ordered list of training objects 1120 can be organized in accordance with a pre-defined rule (heuristic). For example, the order of the items in the ordered list of training objects 1120 can be random (i.e. the first training object 1122, the second training object 1114, the third training object 1126, the fourth training object 1128, the fifth training object 1130 and the sixth training object 1132 can be organized in a random order within the ordered list of training objects 1120).

In alternative non-limiting embodiments of the present technology, the order of the items in the ordered list of training objects 1120 can be organized in accordance with another rule.

Within these embodiments of the present technology, where the training objects (the first training object 1122, the second training object 1114, the third training object 1126, the fourth training object 1128, the fifth training object 1130 and the sixth training object 1132) do not have the inherent temporal relationship, rule-based order becomes a proxy for the temporal order of the training objects that are not otherwise associated with inherent temporal relationship.

Irrespective of how the order 1134 is generated, the order 1134 is then “frozen” and the training objects (the first training object 1122, the second training object 1114, the third training object 1126, the fourth training object 1128, the fifth training object 1130 and the sixth training object 1132) are processed in accordance with this frozen order 1134.

The so-organized order, in a sense, can be said to specify for each one training object (i.e. one of the first training object 1122, the second training object 1114, the third training object 1126, the fourth training object 1128, the fifth training object 1130 and the sixth training object 1132), which other training object occur “before” and which occurs “after”.

As an illustration, let's consider the fourth training object 1128. For the fourth training object 1128, it can be said that:
the first training object 1122, the second training object 1114, the third training object 1126 all occur before the fourth training object 1128; and
the fifth training object 1130 and the sixth training object 1132 both occur after the fourth training object 1128.

In accordance with the non-limiting embodiments of the present technology, as part of evaluating the prediction quality for a given leaf or a given portion of the decision tree, the master server 510 and/or the slave servers 520, 522, 524 generate the prediction quality parameter: (i) for each training object; and (ii) based on targets of only those training objects which have “happened” before the given training object in the ordered list of training objects 1120.

To use a temporal analogy, the master server 510 and/or the slave servers 520, 522, 524 calculate the prediction quality parameter using only those training objects which have happened in the “past” relative to the given training objects. In other words, the prediction quality parameter is calculated without “peeking” into the target of the given training object, and targets of those training objects that happened “in the future” relative to the given training object.

As such, in accordance with the non-limiting embodiments of the present technology, the master server 510 and/or the slave servers 520, 522, 524 iteratively calculate the prediction quality parameter as each new training object gets categorized into the given leaf, using only those training objects that have already been categorized into the given leaf. Once all prediction quality parameters are calculated, they are aggregated (for example, by adding or calculating the average of all so-calculated prediction quality parameter for a given leaf) and, then, eventually, for a given level of the decision tree using all leafs of the given level of the decision tree.

Let's review the process of calculating the prediction quality parameter using the illustration of FIG. 11. At the current stage of the decision tree building, the goal is to calculate the prediction quality parameter for the second level of the proto-tree 1100. More specifically, the master server 510 and/or the slave servers 520, 522, 524 calculate the prediction quality parameter for a given value of the feature and the split for the second node 1104 and the third node 1106.

For the purposes of the illustration to be presented herein below, it shall be assumed that the value of the feature and the split for the second node 1104 has been selected as fn/sn and that the value of the feature and the split for the third node 1106 has been selected as fm/sm. It is the values of the features and the splits that the quality prediction parameters is aims at assessing. In other words, the master server 510 and/or the slave servers 520, 522, 524 calculates the quality prediction parameter for the given level of the decision tree and for the currently selected feature and the split values.

The first training object 1122 is first “descended” via the proto-tree 1100 and the first training object 1122 gets categorized. Let it be assumed that the first training object 1122 is classified into the third node 1106 (the third node 1106 acting as a leaf of the proto-tree 1100). Since the first training object 1122 is the first object in the order 1134, it has no “past objects” and no prediction quality value is calculated. Alternatively, the value of the prediction quality parameter can be calculated as zero.

The second training object 1124 is then “descended” via the proto-tree 1100 and the second training object 1124 gets categorized. Let it be assumed that the second training object 1124 is classified into the second node 1104 (the second node 1104 acting as a leaf of the proto-tree 1100). Even though the second training object 1124 is not the first object in the order 1134, it is the first training object to be classified into the second node 1104 and, hence, it has no “past objects” in the same “leaf”. In accordance with non-limiting embodiments of the present technology, and no prediction quality value is calculated. Alternatively, the value of the prediction quality parameter can be calculated as zero.

The third training object 1126 is then “descended” via the proto-tree 1100 and the third training object 1126 gets categorized. Let it be assumed that the third training object 1126 is classified into the second node 1104 (the second node 1104 acting as a leaf of the proto-tree 1100). The prediction quality parameter for the third training object 1126 is calculated using the “past” of the third training object 1126—namely the first training object 1122, which has also been classified into the second node 1104.

The process is then repeated with the fourth training object 1128, the fifth training object 1130 and the sixth training object 1132. Once all the training objects have been classified and all of the prediction quality features are generated, the prediction quality features of all training objects having been classified to a given node (i.e. the second node 1104 and the third node 1106) are aggregated into the node-level prediction quality parameter. As such, it can be said that for a given node (i.e. the second node 1104 and the third node 1106), the node-level prediction quality parameter is generated based on the individual prediction quality features of training objects that have been classified into the given node, the individual prediction quality features having been generated as described above.

As has been alluded to above, how the individual prediction quality features are aggregated into the node-level prediction quality parameter is not particularly limited. As such, the node-level prediction quality parameter can be generated based on adding up individual prediction quality features of all training objects that have been classified into the given node. Alternatively, the node-level prediction quality parameter can be generated based on calculating an average (or a mean) of individual prediction quality features of all training objects that have been classified into the given node. Yet in additional alternative implementations, the node-level prediction quality parameter can be generated by applying a function to individual prediction quality features of all training objects that have been classified into the given node.

Continuing with the above example, let it be assumed that on the given iteration of the training of the decision tree, the proto-tree has categorized training objects as follows:

TABLE 1

| Second node 1104 | Third node 1106 |
|---|---|
| Second training object 1124 | First training object 1122 |
| Fourth training object 1128 | Third training object 1126 |
| | Fifth training object 1130 |
| | Sixth training object 1132 |

For the second node 1104, the node-level prediction quality parameter can be calculated as follows:

$$NLPQP = \frac{f ( TO 2 ) + f ( TO 4 )}{2} \qquad Formula 2$$

Where NLPQP is the node level prediction quality parameter for the second node 1104, the f(TO2) is the quality parameter associated with the second training object 1124 and the f(TO4) is the prediction quality parameter associated with the fourth training object 1128.

For the third node 1106, the node-level prediction quality parameter can be calculated as follows:

$$NLPQP = \frac{f ( TO 1 ) + f ( TO 3 ) + f ( TO 5 ) + f ( TO 6 )}{4} \qquad Formula 3$$

Where NLPQP is the node level prediction quality parameter for the third node 1106, the f(TO22) is the quality parameter associated with the first training object 1122, the f(TO3) is the prediction quality parameter associated with the third training object 1126, the f(TO5) is the prediction quality parameter associated with the fifth training object 1130, and the f(TO6) is the prediction quality parameter associated with the sixth training object 1132.

It is noted that it is also possible to aggregate the node level prediction quality parameter into a level prediction quality parameter.

Given the architecture described above, it is possible to implement a method for determining a prediction quality parameter for a decision tree in a decision tree prediction model. The method can be executed at a machine learning system that executes the decision tree prediction model. For example, the method can be executed by the master server 510 and/or the slave servers 520, 522, 524.

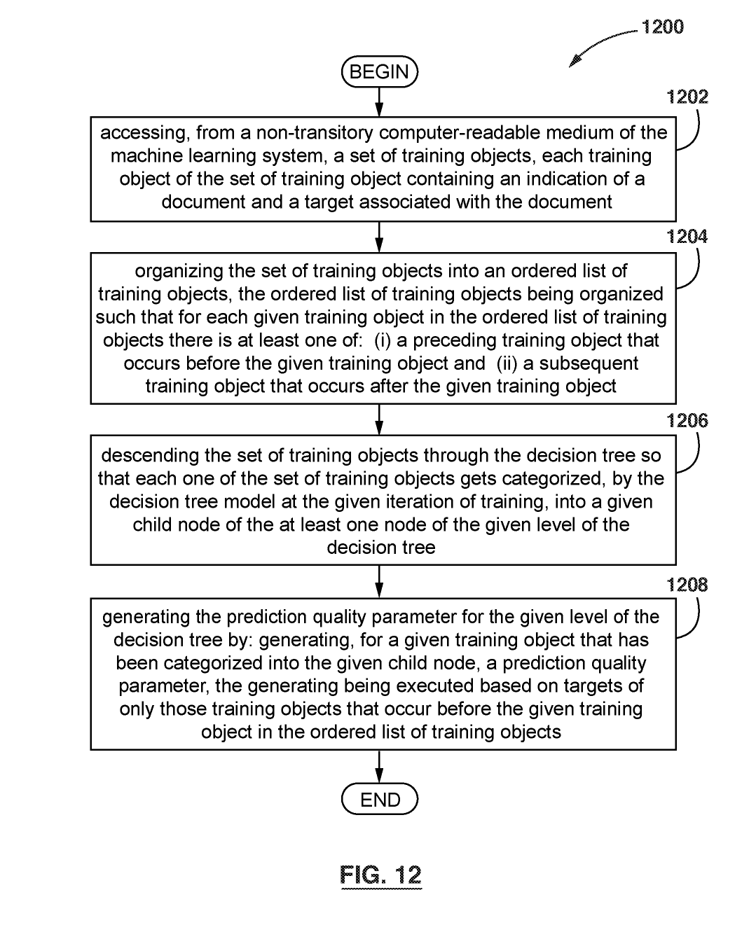

With reference to FIG. 12, there is depicted a block diagram of a method 1200, the method 1200 being executed in accordance with the non-limiting embodiments of the present technology.

Step 1202—accessing, from a non-transitory computer-readable medium of the machine learning system, a set of training objects, each training object of the set of training object containing an indication of a document and a target

The method 1200 begins at step 1202, where the master server 510 and/or the slave servers 520, 522, 524 access, from a non-transitory computer-readable medium of the machine learning system, a set of training objects, each training object of the set of training object containing an indication of a document and a target.

Step 1204—organizing the set of training objects into an ordered list of training objects, the ordered list of training objects is so organized that for each given training object in the ordered list of training objects there is at least one of: (i) a preceding training object that occurs before the given training object and (ii) a subsequent training object that occurs after the given training object

At step 1204, the master server 510 and/or the slave servers 520, 522, 524 organize the set of training objects into an ordered list of training objects. In accordance with embodiments of the present technology, the ordered list of training objects is so organized that for each given training object in the ordered list of training objects there is at least one of: (i) a preceding training object that occurs before the given training object and (ii) a subsequent training object that occurs after the given training object.

As has been alluded to above, in those embodiments where the training objects (the first training object 1122, the second training object 1114, the third training object 1126, the fourth training object 1128, the fifth training object 1130 and the sixth training object 1132) have an inherent temporal relationship, the order of the items in the ordered list of training objects 1120 is organized in accordance with this temporal relationship between the training objects.

In those embodiments where the training objects (the first training object 1122, the second training object 1114, the third training object 1126, the fourth training object 1128, the fifth training object 1130 and the sixth training object 1132) do not have the inherent temporal relationship, the order of the items in the ordered list of training objects 1120 can be organized in accordance with a pre-defined rule (heuristic). For example, the order of the items in the ordered list of training objects 1120 can be random (i.e. the first training object 1122, the second training object 1114, the third training object 1126, the fourth training object 1128, the fifth training object 1130 and the sixth training object 1132 can be organized in a random order within the ordered list of training objects 1120).

In alternative non-limiting embodiments of the present technology, the order of the items in the ordered list of training objects 1120 can be organized in accordance with another rule.

Within these embodiments of the present technology, where the training objects (the first training object 1122, the second training object 1114, the third training object 1126, the fourth training object 1128, the fifth training object 1130 and the sixth training object 1132) do not have the inherent temporal relationship, rule-based order becomes a proxy for the temporal order of the training objects that are not otherwise associated with inherent temporal relationship.

Irrespective of how the order is generated, the order 1134 is then “frozen” and the training objects (the first training object 1122, the second training object 1114, the third training object 1126, the fourth training object 1128, the fifth training object 1130 and the sixth training object 1132) are processed in accordance with this frozen order.

The so-organized order, in a sense, can be said to specify for each one training object (i.e. one of the first training object 1122, the second training object 1114, the third training object 1126, the fourth training object 1128, the fifth training object 1130 and the sixth training object 1132), which other training object occur “before” and which occurs “after”.

Step 1206—descending the set of training objects through the decision tree so that each one of the set of training objects gets categorized into one of the nodes of the given level of the decision tree

At step 1206, the master server 510 and/or the slave servers 520, 522, 524 descend the set of training objects through the decision tree so that each one of the set of training objects gets categorized into one of the nodes of the given level of the decision tree.

Step 1208—generating the prediction quality parameter for the given level of a decision tree by: generating, for a given training object that has been categorized into the given node of the decision tree a prediction quality parameter, the generating being executed based on targets of only those training objects that occur before the given training object in the ordered list of training objects

At step 1208, the master server 510 and/or the slave servers 520, 522, 524 generate the prediction quality parameter for the given level of a decision tree by: generating, for a given training object that has been categorized into the given node of the decision tree a prediction quality parameter, the generating being executed based on targets of only those training objects that occur before the given training object in the ordered list of training objects.

Optional Features of the Method 1200

In some embodiments of the method 1200, the method 1200 further comprises: for a given node having at least one training object categorized in the child node of the given node: amalgamating, into a node-level prediction quality prediction parameter, the prediction quality parameters of the at least one training object.

In some embodiments of the method 1200, the amalgamating, into the node-level prediction quality prediction parameter, the prediction quality parameters of the at least one training object comprises one of: adding all prediction quality parameters of the at least one training object, generating an average of prediction quality parameters of the at least one training object and applying a formula to prediction quality parameters of the at least one training object.

In some embodiments of the method 1200, the method 1200 further comprises for the given level of the decision tree, the given level having at least one node, amalgamating into a total-level prediction quality parameter, node level quality prediction parameter the prediction quality parameters of the at least one node.

In some embodiments of the method 1200, the descending comprises: descending the set of training objects through the decision tree in an order of training object of the ordered list of training objects.

In some embodiments of the method 1200, the generating the prediction quality parameter for the given training object having a given position in the ordered list of training objects comprises: generating the prediction quality parameter based on targets of only those training objects that (i) occur on a position before the given position of the given training object in the ordered list of training objects and (ii) have been categorized in a same leaf.

In some embodiments of the method 1200, the organizing the set of training objects into an ordered list of training objects comprises: generating a plurality of ordered lists of training objects, each of the plurality of ordered lists of training objects being organized such that for each given training object in the ordered list of training objects there is at least one of: (i) a preceding training object that occurs before the given training object and (ii) a subsequent training object that occurs after the given training object; a given one of the plurality of ordered lists of training objects having a least partially different order from others of the plurality of ordered lists of training objects.

In some embodiments of the method 1200, the method 1200 further comprises selecting the given one of the plurality of ordered lists of training objects.

In some embodiments of the method 1200, the selecting is done for each iteration of generating of the prediction quality parameter.

In some embodiments of the method 1200, the selecting is done an entirety of a process of verification of prediction quality for a given decision tree.

In some embodiments of the method 1200, the set of training objects is associated with an inherent temporal relationship of training objects and wherein the organizing the set of training objects into the ordered list of training objects comprises organizing the set of training objects in accordance with the temporal relationship.

In some embodiments of the method 1200, the set of training objects is not associated with an inherent temporal relationship of training objects and wherein the organizing the set of training objects into the ordered list of training objects comprises organizing the set of training objects in accordance with a rule.

In some embodiments of the method 1200, the set of training objects is not associated with an inherent temporal relationship of training objects and wherein the organizing the set of training objects into the ordered list of training objects comprises organizing the set of training objects in a randomly generated order.

“Do not Look Ahead” Implementation—Multiple Decision Trees/Ensemble of Trees

As has been alluded to above, in alternative implementations of the present technology, the “do not look ahead” paradigm is applied to multiple decision trees/ensemble of decision trees. More specifically, during the implementation of the gradient boosting of trees and building the ensemble of decision trees (each of which is built based on inter alia an outcome of preceding trees in order to enhance prediction quality of the previous decision trees). In accordance with non-limiting embodiments of the present technology, the “don't look ahead” approach, as described above in relation to building a single tree, is implemented to the process of building multiple decision trees, as part of an ensemble during the boosting approach.

In general, an MLA function ƒ(x) for a given training object x depends not only on targets of training objects which precede the given training object in the “timeline” (order) and got into the same leaf as the given training object in the current tree, but also on the approximations (i.e. predictions) for this training object x made by preceding decision trees. These predictions of the previous iterations of the decision trees are referred to herein as “approximations”. In other words, an approximation for a given training object x is a prediction made by the previously built trees, as well as the current iteration of the decision tree, for the given training object x.

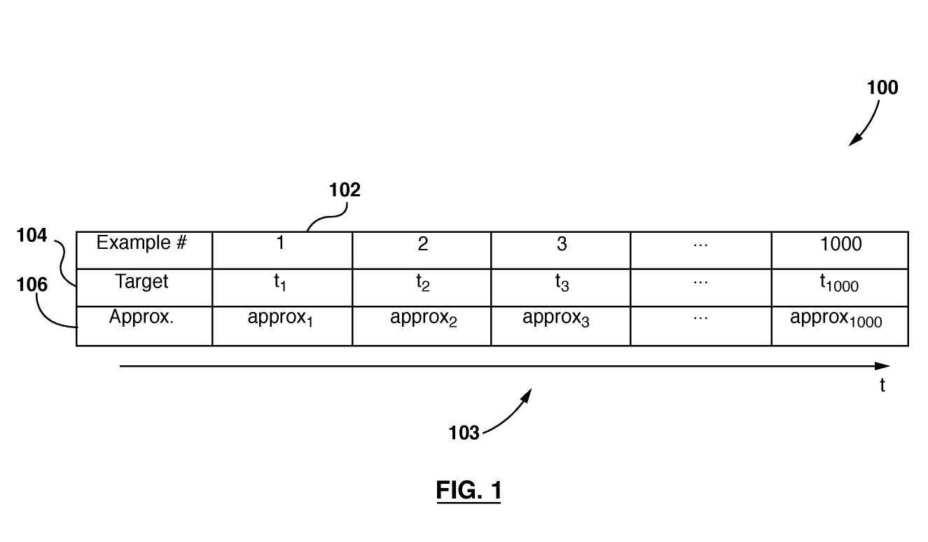

The master server 510 and/or the slave servers 520, 522, 524 generate and maintain the table 100 depicted in FIG. 1. The table 100 stores prediction results for each of the training objects x, the prediction results having been generated during earlier iteration of training and validation of the decision tree model.

The table 100 maps the given training object 102, to its associated target 104 (i.e. the actual value of the target, which the MLA is attempting to predict) and its associated approximation 106 (i.e. a totality of predictions for the training object 102 made by previous iterations of the decision trees).

There is also schematically depicted the approximation vector 103. The approximation vector 103 is a vector of correct answers for all the depicted example objects (one through to one thousand in the illustration depicted in FIG. 1).

The approximation vector 103 can also be said to be a vector of outcomes of prediction of the prediction model currently deployed by the MLA as a whole. In other words, the approximation vector 103 represents prediction outcomes for all training objects 102, rendered by a combination of decision trees built at the current stage of boosting of the decision trees by the MLA. In the simplest implementation of the non-limiting embodiments of the present technology, each approximation of the approximation vector 103 is a sum of previous predictions for the given training object 102.

When the master server 510 and/or the slave servers 520, 522, 524 initiate the boosting the decision trees, the approximation vector 103 contains only zeros (since no previous iterations of the decision trees have been built and, thus, no previous predictions outcomes are yet available). As the master server 510 and/or the slave servers 520, 522, 524 continue to implement boosting (and, thus, building additional decision trees in the ensemble of the decision trees), through the focus on the “weakest learners” of the previous iterations of decision trees, the approximation vector 103 starts to resemble more and more a vector of targets (not depicted). In other words, the goal is, for the master server 510 and/or the slave servers 520, 522, 524 while executing boosting, to bring approximation of the targets to the actual values of the targets as much as possible.

Turning back to the example of the training object x in a given leaf at a given bosting stage n, in accordance with the non-limiting embodiments of the present technology, a prediction for the training object x (i.e. a new approximation for the given boosting stage n), in a given new tree will be a function of targets and approximations of training object(s) that (i) have been categorized (placed) into the same leaf as the training object x in the new tree and (ii) are located on the ordered list of training objects before the given training object x.

The master server 510 and/or the slave servers 520, 522, 524 can apply Formula 1 for calculation of the approximation.

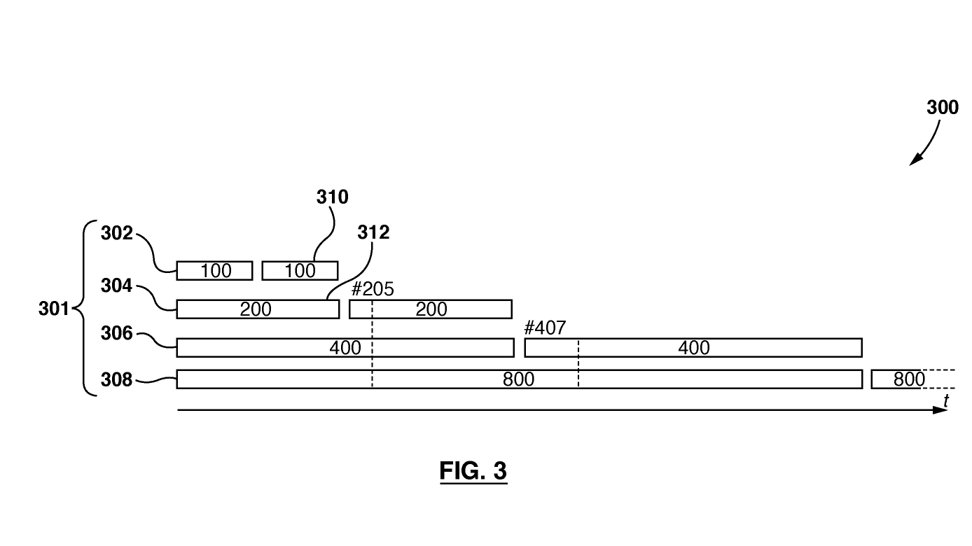

In accordance with non-limiting embodiments of the present technology, the master server 510 and/or the slave servers 520, 522, 524 first, splits the ordered list of training object into chunks. With reference to FIG. 3, the master server 510 and/or the slave servers 520, 522, 524 splits the ordered list of training objects into the plurality of chunks 301.

The plurality of chunks 301 comprises chunks of several levels—the first level chunks 302, the second level chunks 304, the third level chunks 306, the fourth level chunks 308, etc. In the depicted embodiment, each level of chunks (i.e. chunks of the first level chunks 302, the second level chunks 304, the third level chunks 306, and the fourth level chunks 308) contains two chunks—a first chunk and a second chunk of the given level.

Each chunk within a given level chunks contains a certain pre-defined number of training example objects. As an example only, a given first level chunk 310 of the first level chunks 302 contains 100 of the ordered training objects. In the depicted example, the first level chunks 302 contain two instances of the given first level chunks 310 (containing 100 training object each or 200 training objects in total).

The given second level chunk 312 of the second level chunks 304, contains a number of training object that is greater than the number of training objects contained by the given first level chunk 310. In the depicted embodiment, the number of training objects stored in the given second level chunk 312 is twice the number of training objects stored by the given first level chunk 310.

More specifically, where the given first level chunk 310 contains 100 of the ordered training objects, the given second level chunk 312 contains 200 of the ordered training object. What it means, in turn, is that the given second level chunk 312 (such as the first given second level chunk 312) can contain the same ordered training objects as two given first level chunks 310. However, some of the second level chunks 312 (such as the second given second level chunk 312) have ordered training objects that do not belong to any of the first level chunks 310.

Thus, it can be said that a given training object can get allocated into several chunks of the plurality of chunks 301. For example, a 105^{th} training object is located in: a second given first level chunk 302 containing 100 ordered training objects, the first given second level chunk 312 containing 200 ordered training objects, a first given third level chunk (not numbered) containing 700 training objects, a first given fourth level chunk (not numbered) containing 800 training objects, etc.

As another example, a 205^{th} training object is located in: none of the first level chunks 302 containing 100 ordered training objects, the second given second level chunk 312 containing 200 ordered training objects, the first given third level chunk (not numbered) containing 700 training objects, the first given fourth level chunk (not numbered) containing 800 training objects, etc.

Broadly speaking, the master server 510 and/or the slave servers 520, 522, 524 calculates approximations of the training objects located in, for example, the first given second level chunk 312 containing 200 training objects are calculated based on all training objects located therein and none of the training objects located in the second given second level chunk (not numbered). Therefore, for the training objects located in the first given second level chunk 312 containing 200 training objects using the “past” of all training objects located therein.

To illustrate, let's consider the 205^{th} training object. The master server 510 and/or the slave servers 520, 522, 524 calculate approximates for the 205^{th} training object based on those chunks where the 205^{th} training object is located (and all training objects located therein)—i.e. the second given second level chunk 312 containing 200 ordered training objects, the first given third level chunk (not numbered) containing 700 training objects, the first given fourth level chunk (not numbered) containing 800 training objects, etc. When the master server 510 and/or the slave servers 520, 522, 524 need to calculate approximates of the for the 407^{th} training object based on the 205^{th} training object being located in the same leaf as the 407^{th} training object (i.e. based on the “past” of the 407^{th} training object) the master server 510 and/or the slave servers 520, 522, 524 use approximates of the 205^{th} training object based solely on the first third level chunk (not numbered), i,e. the largest chunk that does not contain the future of the 407^{th} training object.

Put another way, in order to calculate prediction value for a given training object located in a given leaf, the master server 510 and/or the slave servers 520, 522, 524 use approximates of “neighboring” training objects (i.e. those training objects located in the same leaf and located “earlier” in the ordered list of training objects). The approximates of the neighbouring training objects are taken based on the largest chunk, not containing the given training object, in other words, based on the largest chunk not containing data from the “future” of the given training object.

In some embodiments of the present technology, the master server 510 and/or the slave servers 520, 522, 524 may pre-organize a plurality of ordered lists of training objects, i.e. generate different “timelines”. In some embodiments of the present technology, the master server 510 and/or the slave servers 520, 522, 524 generate a pre-determined number of ordered lists, such as three (as an example only). In other words, the master server 510 and/or the slave servers 520, 522, 524 generate a first ordered list of training objects, a second ordered list of training objects, and a third ordered list of training objects. Then, in operation, for each prediction, the master server 510 and/or the slave servers 520, 522, 524 can use a randomly selected one of the first ordered list of training objects, the second ordered list of training objects, and the third ordered list of training objects. In alternative embodiments of the present technology, the master server 510 and/or the slave servers 520, 522, 524 can use a randomly picked one of the first ordered list of training objects, the second ordered list of training objects, and the third ordered list of training objects per decision tree of the ensemble of decision trees.

Given the architecture described above, it is possible to implement a method for determining a prediction quality parameter for a decision tree in a decision tree prediction model. The given level of the decision tree has at least one node, the prediction quality parameter being for evaluating prediction quality of the decision tree prediction model at a given iteration of training of the decision tree, the given iteration of training of the decision tree having at least one previous iteration of training of a previous decision tree, the decision tree and the previous decision tree forming an ensemble of tree generated using a decision tree boosting technique.

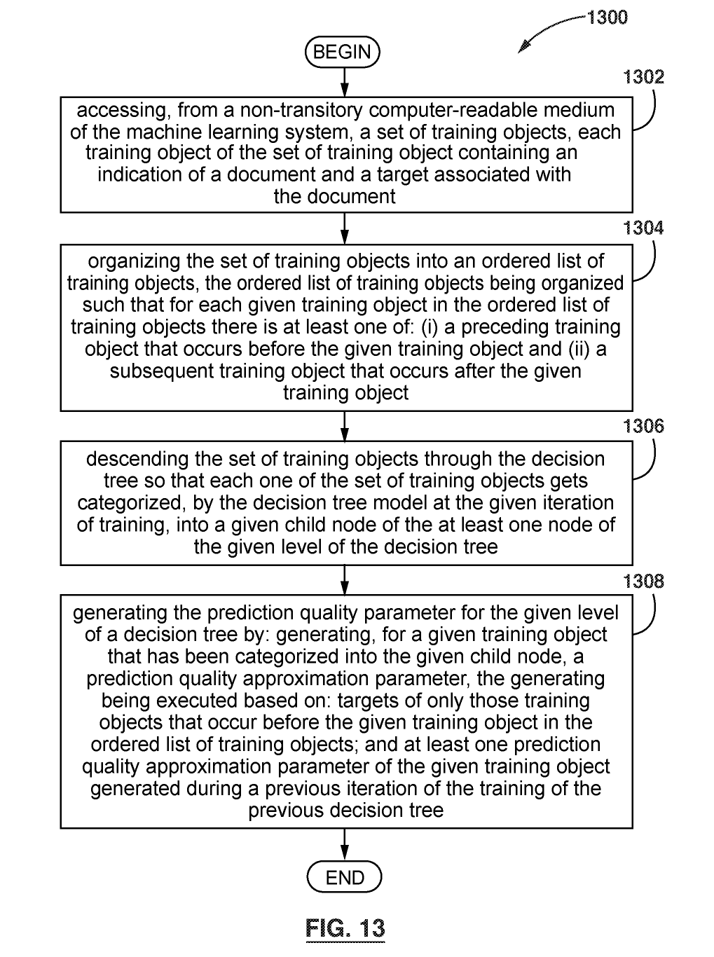

The method can be executed at a machine learning system that executes the decision tree prediction model. For example, the method can be executed by the master server 510 and/or the slave servers 520, 522, 524. With reference to FIG. 13, there is depicted a block diagram of a method 1300, the method 1300 being executed in accordance with the non-limiting embodiments of the present technology.

1302—accessing, from a non-transitory computer-readable medium of the machine learning system, a set of training objects, each training object of the set of training object containing an indication of a document and a target associated with the document

The method 1300 begins at step 1302, where the master server 510 and/or the slave servers 520, 522, 524 access, from a non-transitory computer-readable medium of the machine learning system, a set of training objects, each training object of the set of training object containing an indication of a document and a target associated with the document.

1304—organizing the set of training objects into an ordered list of training objects, the ordered list of training objects is organized such that for each given training object in the ordered list of training objects there is at least one of: (i) a preceding training object that occurs before the given training object and (ii) a subsequent training object that occurs after the given training object

At step 1304, the master server 510 and/or the slave servers 520, 522, 524 organize the set of training objects into an ordered list of training objects, the ordered list of training objects is organized such that for each given training object in the ordered list of training objects there is at least one of: (i) a preceding training object that occurs before the given training object and (ii) a subsequent training object that occurs after the given training object.

1306—descending the set of training objects through the decision tree so that each one of the set of training objects gets categorized, by the decision tree model at the given iteration of training, into a given child node of the at least one node of the given level of the decision tree

At step 1306, the master server 510 and/or the slave servers 520, 522, 524 descends the set of training objects through the decision tree so that each one of the set of training objects gets categorized, by the decision tree model at the given iteration of training, into a given child node of the at least one node of the given level of the decision tree.

1308—generating the prediction quality parameter for the given level of a decision tree by: generating, for a given training object that has been categorized into the given child node, a prediction quality approximation parameter, the generating being executed based on: targets of only those training objects that occur before the given training object in the ordered list of training objects; and at least one prediction quality approximation parameter of the given training object generated during the previous iteration of the training of the previous decision tree

At step 1308, the master server 510 and/or the slave servers 520, 522, 524 generates the prediction quality parameter for the given level of a decision tree by: generating, for a given training object that has been categorized into the given child node, a prediction quality approximation parameter, the generating being executed based on: targets of only those training objects that occur before the given training object in the ordered list of training objects; and at least one prediction quality approximation parameter of the given training object generated during the previous iteration of the training of the previous decision tree.

Optional Enhancements of the Method 1300

In some implementations of the method 1300, the method 1300 further comprises calculating an indication of the at least one quality approximation parameter of the given training object generated during the previous iteration of the training of the previous decision tree.

In some implementations of the method 1300, the calculating comprises: splitting the ordered list of training objects into a plurality of chunks, the plurality of chunks being organized into at least two levels of chunks.

In some implementations of the method 1300, a chunk of a given level of chunks contains a first pre-defined number of training objects and wherein a chunk of a lower level of chunks contains a different pre-defined number of training objects, the different pre-defined number of training objects being greater than the first pre-defined number of training objects.

In some implementations of the method 1300, a chunk of a given level of chunks contains a first pre-defined number of training objects and wherein a chunk of a lower level of chunks contains the first pre-defined number of training objects and a second set of training objects located sequentially after the first pre-defined number of training objects in the ordered list, a number of training objects within the second set of training objects being the same as the pre-defined number of training objects.

In some implementations of the method 1300, the calculating the indication of the at least one quality approximation parameter of the given training object generated during the previous iteration of the training of the previous decision tree comprises: for the given training object, calculating at least one quality approximation parameter based on the training objects located in the same chunk as the given training object.

In some implementations of the method 1300, the generating the prediction quality parameter for the given level of a decision tree comprises: using quality approximation parameters of past training objects located in a largest chunk that does not contain the given training object.

In some implementations of the method 1300, the organizing the set of training objects into an ordered list of training objects comprises: generating a plurality of ordered lists of training objects, each of the plurality of ordered lists of training objects being organized such that for each given training object in the ordered list of training objects there is at least one of: (i) a preceding training object that occurs before the given training object and (ii) a subsequent training object that occurs after the given training object; a given one of the plurality of ordered lists of training objects having a least partially different order from others of the plurality of ordered lists of training objects.

In some implementations of the method 1300, the method 1300 further comprising selecting the given one of the plurality of ordered lists of training objects.

In some implementations of the method 1300, the selecting is done for each iteration of generating of the prediction quality parameter.

In some implementations of the method 1300, the selecting is done an entirety of a process of verification of prediction quality for a given decision tree.

In some implementations of the method 1300, the set of training objects is associated with an inherent temporal relationship of training objects and wherein the organizing the set of training objects into the ordered list of training objects comprises organizing the set of training objects in accordance with the temporal relationship.

In some implementations of the method 1300, the set of training objects is not associated with an inherent temporal relationship of training objects and wherein the organizing the set of training objects into the ordered list of training objects comprises organizing the set of training objects in accordance with a rule.

In some implementations of the method 1300, the set of training objects is not associated with an inherent temporal relationship of training objects and wherein the organizing the set of training objects into the ordered list of training objects comprises organizing the set of training objects in a randomly generated order.

Specific embodiments of the embodiments of the present technology can be implemented using various mathematical principles encoded into proper computer-executable instructions to execute the various methods and routines described herein. An example of such principles is described in an article entitled “Fighting biases with dynamic boosting” by Dorogush et al., submitted to Cornell University Library on 28 Jun. 2017 and available from arXiv; the content of which article is hereby incorporated in its entirety).

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of determining a prediction quality parameter for a decision tree in a decision tree prediction model,
a given level of the decision tree having at least one node,
the prediction quality parameter being for evaluating prediction quality of the decision tree prediction model at a given iteration of training of the decision tree,
the method being executable at a machine learning system that executes the decision tree prediction model,
the method comprising:
accessing, from a non-transitory computer-readable medium of the machine learning system, a set of training objects, each training object of the set of training object containing an indication of a document and a target associated with the document;
organizing the set of training objects into an ordered list of training objects, the ordered list of training objects is organized such that for each given training object in the ordered list of training objects there is at least one of:
(i) a preceding training object that occurs before the given training object and
(ii) a subsequent training object that occurs after the given training object;
descending the set of training objects through the decision tree so that each one of the set of training objects gets categorized, by the decision tree model at the given iteration of training, into a given child node of the at least one node of the given level of the decision tree;
generating the prediction quality parameter for the decision tree by:
generating, for a given training object that has been categorized into the given child node, a prediction quality parameter, the generating being executed based on targets of only those training objects that occur before the given training object in the ordered list of training objects.

2. The method of claim 1, further comprising:
for a given node having at least one training object categorized in the child node of the given node:
amalgamating, into a node-level prediction quality prediction parameter, the prediction quality parameters of the at least one training object.

3. The method of claim 2, wherein the amalgamating, into the node-level prediction quality prediction parameter, the prediction quality parameters of the at least one training object comprises one of:
adding all prediction quality parameters of the at least one training object, generating an average of prediction quality parameters of the at least one training object and applying a formula to prediction quality parameters of the at least one training object.

4. The method of claim 1, further comprising:
for the given level of the decision tree, the given level having at least one node, amalgamating into a total-level prediction quality parameter, node level quality prediction parameter the prediction quality parameters of the at least one node.

5. The method of claim 1, wherein descending comprises:
descending the set of training objects through the decision tree in an order of training object of the ordered list of training objects.

6. The method of claim 5, wherein the generating the prediction quality parameter for the given training object having a given position in the ordered list of training objects comprises:
generating the prediction quality parameter based on targets of only those training objects that (i) occur on a position before the given position of the given training object in the ordered list of training objects and (ii) have been categorized in a same leaf.

7. The method of claim 1, wherein the organizing the set of training objects into an ordered list of training objects comprises:
generating a plurality of ordered lists of training objects, each of the plurality of ordered lists of training objects being organized such that for each given training object in the ordered list of training objects there is at least one of:
(i) a preceding training object that occurs before the given training object and
(ii) a subsequent training object that occurs after the given training object;
a given one of the plurality of ordered lists of training objects having a least partially different order from others of the plurality of ordered lists of training objects.

8. The method of claim 7, further comprising selecting the given one of the plurality of ordered lists of training objects.

9. The method of claim 8, wherein the selecting is done for each iteration of generating of the prediction quality parameter.

10. The method of claim 8, wherein the selecting is done an entirety of a process of verification of prediction quality for a given decision tree.

11. The method of claim 1, wherein the set of training objects is associated with an inherent temporal relationship of training objects and wherein the organizing the set of training objects into the ordered list of training objects comprises organizing the set of training objects in accordance with the temporal relationship.

12. The method of claim 1, wherein the set of training objects is not associated with an inherent temporal relationship of training objects and wherein the organizing the set of training objects into the ordered list of training objects comprises organizing the set of training objects in accordance with a rule.

13. The method of claim 1, wherein the set of training objects is not associated with an inherent temporal relationship of training objects and wherein the organizing the set of training objects into the ordered list of training objects comprises organizing the set of training objects in a randomly generated order.

14. A method of determining a prediction quality parameter for a decision tree prediction model,
a given level of the decision tree having at least one node,
the prediction quality parameter being for evaluating prediction quality of the decision tree prediction model at a given iteration of training of the decision tree, the given iteration of training of the decision tree having at least one previous iteration of training of a previous decision tree, the decision tree and the previous decision tree forming an ensemble of tree generated using a decision tree boosting technique,
the method being executable at a machine learning system that executes the decision tree prediction model,
the method comprising:
accessing, from a non-transitory computer-readable medium of the machine learning system, a set of training objects, each training object of the set of training object containing an indication of a document and a target associated with the document;
organizing the set of training objects into an ordered list of training objects, the ordered list of training objects is organized such that for each given training object in the ordered list of training objects there is at least one of:
(i) a preceding training object that occurs before the given training object and
(ii) a subsequent training object that occurs after the given training object;
descending the set of training objects through the decision tree so that each one of the set of training objects gets categorized, by the decision tree model at the given iteration of training, into a given child node of the at least one node of the given level of the decision tree;
generating the prediction quality parameter for the given level of a decision tree by:
generating, for a given training object that has been categorized into the given child node, a prediction quality approximation parameter, the generating being executed based on:
targets of only those training objects that occur before the given training object in the ordered list of training objects; and
at least one prediction quality approximation parameter of the given training object generated during the previous iteration of the training of the previous decision tree.

15. The method of claim 14, wherein the method further comprises calculating an indication of the at least one quality approximation parameter of the given training object generated during the previous iteration of the training of the previous decision tree.

16. The method of claim 15, wherein the calculating comprises:
splitting the ordered list of training objects into a plurality of chunks, the plurality of chunks being organized into at least two levels of chunks.

17. The method of claim 16, wherein a chunk of a given level of chunks contains a first pre-defined number of training objects and wherein a chunk of a lower level of chunks contains a different pre-defined number of training objects, the different pre-defined number of training objects being greater than the first pre-defined number of training objects.

18. The method of claim 16, wherein a chunk of a given level of chunks contains a first pre-defined number of training objects and wherein a chunk of a lower level of chunks contains the first pre-defined number of training objects and a second set of training objects located sequentially after the first pre-defined number of training objects in the ordered list, a number of training objects within the second set of training objects being the same as the first pre-defined number of training objects.

19. The method of claim 16, wherein the calculating the indication of the at least one quality approximation parameter of the given training object generated during the previous iteration of the training of the previous decision tree comprises:
for the given training object, calculating at least one quality approximation parameter based on the training objects located in the same chunk as the given training object.

20. The method of claim 19, wherein the generating the prediction quality parameter for the given level of a decision tree comprises:
using quality approximation parameters of past training objects located in a largest chunk that does not contain the given training object.

21. The method of claim 14, wherein the organizing the set of training objects into an ordered list of training objects comprises:
generating a plurality of ordered lists of training objects, each of the plurality of ordered lists of training objects being organized such that for each given training object in the ordered list of training objects there is at least one of:
(i) a preceding training object that occurs before the given training object and
(ii) a subsequent training object that occurs after the given training object;
a given one of the plurality of ordered lists of training objects having a least partially different order from others of the plurality of ordered lists of training objects.

22. The method of claim 21, further comprising selecting the given one of the plurality of ordered lists of training objects.

23. The method of claim 22, wherein the selecting is done for each iteration of generating of the prediction quality parameter.

24. The method of claim 22, wherein the selecting is done an entirety of a process of verification of prediction quality for a given decision tree.

25. The method of claim 14, wherein the set of training objects is associated with an inherent temporal relationship of training objects and wherein the organizing the set of training objects into the ordered list of training objects comprises organizing the set of training objects in accordance with the temporal relationship.

26. The method of claim 14, wherein the set of training objects is not associated with an inherent temporal relationship of training objects and wherein the organizing the set of training objects into the ordered list of training objects comprises organizing the set of training objects in accordance with a rule.

27. The method of claim 14, wherein the set of training objects is not associated with an inherent temporal relationship of training objects and wherein the organizing the set of training objects into the ordered list of training objects comprises organizing the set of training objects in a randomly generated order.

28. A server configured to execute a Machine Learning Algorithm (MLA), the MLA being based on a decision tree prediction model based on a decision tree, a given level of the decision tree having at least one node, the server further configured to:
access, from a non-transitory computer-readable medium of the server, a set of training objects, each training object of the set of training object containing an indication of a document and a target associated with the document;
organize the set of training objects into an ordered list of training objects, the ordered list of training objects is organized such that for each given training object in the ordered list of training objects there is at least one of:
(i) a preceding training object that occurs before the given training object and
(ii) a subsequent training object that occurs after the given training object;
descend the set of training objects through the decision tree so that each one of the set of training objects gets categorized, by the decision tree prediction model at the given iteration of training, into a given child node of the at least one node of the given level of the decision tree;
generate a prediction quality parameter for the given level of a decision tree, the prediction quality parameter being for evaluating prediction quality of the decision tree prediction model at a given iteration of training of the decision tree, by:
generating, for a given training object that has been categorized into the given child node, a prediction quality parameter, the generating being executed based on targets of only those training objects that occur before the given training object in the ordered list of training objects.

29. A server configured to execute a Machine Learning Algorithm (MLA), the MLA being based on a decision tree prediction model based on a decision tree, a given level of the decision tree having at least one node, the server further configured to:
access, from a non-transitory computer-readable medium of the machine learning system, a set of training objects, each training object of the set of training object containing an indication of a document and a target associated with the document;
organize the set of training objects into an ordered list of training objects, the ordered list of training objects is organized such that for each given training object in the ordered list of training objects there is at least one of:
(i) a preceding training object that occurs before the given training object and
(ii) a subsequent training object that occurs after the given training object;
descend the set of training objects through the decision tree so that each one of the set of training objects gets categorized, by the decision tree model at the given iteration of training, into a given child node of the at least one node of the given level of the decision tree;
generate a prediction quality parameter for the given level of a decision tree, the prediction quality parameter being for evaluating prediction quality of the decision tree prediction model at a given iteration of training of the decision tree, the given iteration of training of the decision tree having at least one previous iteration of training of a previous decision tree, the decision tree and the previous decision tree forming an ensemble of tree generated using a decision tree boosting technique, by:
generating, for a given training object that has been categorized into the given child node, a prediction quality approximation parameter, the generating being executed based on:
targets of only those training objects that occur before the given training object in the ordered list of training objects; and
at least one prediction quality approximation parameter of the given training object generated during the previous iteration of the training of the previous decision tree.

30. A method of determining a prediction quality parameter for a decision tree prediction model,
a given level of the decision tree having at least one node,
the prediction quality parameter being for evaluating prediction quality of the decision tree prediction model at a given iteration of training of the decision tree, the given iteration of training of the decision tree having at least one previous iteration of training of a previous decision tree, the decision tree and the previous decision tree forming an ensemble of tree generated using a decision tree boosting technique,
the method being executable at a machine learning system that executes the decision tree prediction model,
the method comprising:
accessing, from a non-transitory computer-readable medium of the machine learning system, a set of training objects, each training object of the set of training object containing an indication of a document and a target associated with the document;
organizing the set of training objects into an ordered list of training objects, the ordered list of training objects is organized such that for each given training object in the ordered list of training objects there is at least one of:
(i) a preceding training object that occurs before the given training object and
(ii) a subsequent training object that occurs after the given training object;
descending the set of training objects through the decision tree so that each one of the set of training objects gets categorized, by the decision tree model at the given iteration of training, into a given child node of the at least one node of the given level of the decision tree;
generating the prediction quality parameter for the given level of a decision tree by:
generating, for a given training object that has been categorized into the given child node, a prediction quality approximation parameter, the generating being executed based on:
targets of only those training objects that occur before the given training object in the ordered list of training objects; and
at least one prediction quality approximation parameter of the given training object generated during the previous iteration of the training of the previous decision tree;
calculating an indication of the at least one quality approximation parameter of the given training object generated during the at least one previous iteration of the training of the previous decision tree by splitting the ordered list of training objects into a plurality of chunks, the plurality of chunks being organized into at least two levels of chunks.
